(19) United States
(12) Patent Application Publication
(10) Pub. No.: US 2019/0057445 A1
(43) Pub. Date: Feb. 21, 2019

(54) System And Processes To Reduce And Redirect Inaccuracies In Computationally Irreducible Electronic Exchange Data Systems

(71) Applicants: Jack Fonss, New Canaan, CT (US); Maxwell John Fonss, New Canaan, CT (US)

(72) Inventors: Jack Fonss, New Canaan, CT (US); Maxwell John Fonss, New Canaan, CT (US)

(21) Appl. No.: 16/165,521

(22) Filed: Oct. 19, 2018

Related U.S. Application Data
(60) Provisional application No. 62/608,305, filed on Dec. 20, 2017.

(51) Int. Cl. G06Q 40/04; G06Q 20/36

(52) U.S. Cl. CPC G06Q 40/04; G06Q 20/36

(57) ABSTRACT

A non-conventional method and system, linked to an electronic exchange and functionally interposed between an electronic exchange and an internet linked data stream to monitor for equilibrium conditions, to conduct automated curative processes, to improve data accuracy in fewer transaction cycles, and to redirect non-equilibrium differentials through curative processes to produce fair and equitable electronic exchange results for more participants. The system utilizes recursive processes and may invoke machine learning sub-processes to improve the accuracy of results and to reduce the number of electronic transactions or modifications required to achieve equilibriums and improved market fairness.

### CROSS-REFERENCE TO RELATED APPLICATION

The present application claims the benefit of the filing date of U.S. Provisional Patent Application No. 62/608,305, filed Dec. 20, 2017, the disclosure of which is hereby incorporated herein by reference.

### FIELD OF USE

A system, method, and a computer readable medium that decreases computer processing time to market equilibrium conditions by utilization of fewer transaction cycles to minimize and redirect electronic trading data inaccuracies. The disclosed system, method, and computer readable medium may be utilized across a wide range of environments where electronic price data streams of instruments, indices, and collective vehicles are electronically published and transacted.

### BACKGROUND

The majority of collective investment vehicles (or collective vehicles) in the U.S. are in the form of exchange traded funds (ETFs), mutual funds, closed-end funds, exchange traded notes, and segregated trust vehicles. Most collective vehicles consume large quantities of real-time and static data, generally accessed through direct or indirect linkages to one or more electronic exchanges or internet-linked market data outlets. Additionally, most collective vehicles create and disseminate large volumes of data which are generally transmitted back to electronic exchanges and published on a range of internet data and news outlets; the collective vehicle transmitted data is often a derivative or transformed form of the accessed data where it is altered through a range of factors including an impact from activities on a different electronic market, an altered correlation, or modified linkage properties. Collective vehicle data generation usually include electronic trading prices, electronic indicative intraday (or intrasession) values, system generated net asset values, stored data parameters, and a range of measured differentials.

A principle purpose of collective vehicles is to bundle a collection of financial positions into a single electronically tradable instrument. Another purpose of collective vehicles is to deliver expert or algorithmic investment selection to a wide audience at reduced cost. ETFs can deliver generic over-the-counter investment services at low cost, and their ease of electronic trading has made them a preferred alternative to non-exchange traded alternatives. Despite remarkable growth over the last two decades, the electronic trading of ETFs continues to rely on loose associations of market participants to properly function; novel, modernized and specialized systems for ensuring low latency electronic data and redundancy in accurate executions are absent.

Electronic access to collective vehicles provides an important function for both small retail investors and larger institutional investors. These vehicles can deliver unique access to instruments, markets, returns, and directionality that is often otherwise unobtainable in other instruments. As an important public policy matter, individual investors can benefit from the scale, operational, and computer process capabilities of global institutions which can supply the trading, settlement and valuation activities on behalf of individual investors through collective vehicles. As detailed below, many of the benefits delivered to individuals through the collective vehicle format, may be defeated in practice because of longstanding uncontrolled electronic price data conditions.

Most known techniques and processes are directed at risk management and hedging activities, where a combination of staffing, computer resources, and data input are generally used to buy and sell instruments in prescribed quantities at given times.

The mutual fund is one of the oldest forms of vehicles, and mutual funds continue to enjoy the largest amount of assets outstanding. Mutual funds have advantages over ETFs for active management, stock picking, and proprietary strategies because they are not generally limited to a prescribed list of securities, and they are not generally required to publicly report daily positions; proprietary strategies do not get diluted through real-time disclosure where outside traders may front-run a fund's strategies. Mutual funds differ from ETFs in that mutual funds transact directly with their beneficial owners without the inefficiency or slippage of intermediaries. However, the mutual fund format is falling out of favor in the U.S. due to its higher cost structure, the lack of intra-session liquidity, and the inability to engage in in-kind exchanges for long-standing asset positions.

ETFs have been available in the U.S. markets for more than twenty years, and for most of that time, ETFs have been the fastest growing form of investment vehicle. ETFs are widely believed to be a preferred over mutual funds largely because of their lower cost of acquisition and their intraday liquidity; ETFs are structured to be electronically traded like stocks during market hours, while mutual fund owners must submit a redemption order prior to a daily cut-off time and may then only redeem at a market end-of-day close.

To date, a number of the earliest and largest ETFs have tended to perform as planned, generating timely, cost efficient, and accurate returns. Of considerable concern is that most of the industry's growth and observable performance has occurred in relatively stable, benign, and almost continuously rising markets; during the few market dislocations which have occurred, ETF performance has been mixed, and their electronic trading prices have sometimes deviated materially from intrinsic values in times of high market volatility. Conditions have developed that require new forms of network communication, software processes, and specialized machine processes running in multiple modes.

In order to operate effectively, ETFs rely on consistent diligence from a range of independent market participants who are generally engaged in electronic trading market making and market arbitrage. However these market participants act opportunistically and factors such as increased capital standards, changing regulation, and changing market environments jeopardize the performance of systems which rely on the anticipated arbitrage and electronic market making activities of independent and unrelated third parties.

More specifically, current ETFs, ETF-like vehicles, and their tradable interests, rely on a loose and uncommitted group of special market makers to both facilitate electronic trading of the related interests and to create internet-based pricing data which is accurate and timely. Because the electronically tradable interests of ETF and ETF-like vehicles are an aggregation of positions used to track an index or prescribed strategy, the data and system function of these vehicles becomes useless and even potentially damaging to electronic trading markets if the price data is inaccurate or if it suffers from material latency. Known tradable vehicles and vehicle systems rely on the opportunistic activity of unaffiliated special market makers to submit electronic trade orders and to execute simultaneous electronic trades in the collective vehicle interests and underlying vehicle positions; often those simultaneous electronic trades must be executed in and routed to different venues and different markets. These special market makers are typically referred to as authorized participants (APs), and in conventional implementations of known systems, authorized participants are unrelated opportunistic actors who are expected to monitor price differentials derived from internet data streams (measured between a collective vehicle's issued interests and its underlying positions) and to capitalize on those differentials to gain arbitrage profits by engaging in simultaneous or near-simultaneous electronic trades over the interests (or shares) of a collective vehicle and its underlying positions.

The AP arrangement dates back more than 20 years when many of the world's largest banks acted as APs and were consistently reliable market makers. Prior to current regulation and market fragmentation, market making in electronic trading was consistently profitable because of higher commissions, fractional price quotations (contrasted with today's decimalized quotations), and lower capital costs. More market complexity and fewer large well-capitalized institutions prepared to operate as APs has made the known methods and systems fragile, and has subjected the related electronic trading systems to inaccuracy, excess latency, and reduced fairness.

The U.S. Securities and Exchange Investor Bulletin “Exchange Traded Funds (ETFs)” (www.investor.gov/additional-resources/news-alerts/alerts-bulletins/investor-bulletin-exchange-traded-funds-etfs) describes the reliance which electronic trading and ETF holders have on unrelated intermediaries and the resultant accuracy and latency problems electronic traders face:
“Unlike with mutual fund shares, retail investors can only purchase and sell ETF shares in market transactions. That is, unlike mutual funds, ETFs do not sell individual shares directly to, or redeem their individual shares directly from, retail investors. Instead, ETF sponsors enter into contractual relationships with one or more financial institutions known as “‘Authorized Participants’”. Authorized Participants typically are large broker-dealers. Only Authorized Participants are permitted to purchase and redeem shares directly from an ETF . . . ” (SEC “Investor Bulletin: Exchange Traded Funds (ETFs)”, p. 2.)
“For a variety of reasons, an ETF's market price may trade at a premium or a discount to its underlying value. When an Authorized Participant identifies that an ETF's shares are trading at either a premium or a discount to their estimated net asset value, it may engage in trading strategies that are expected to result in the market price of an ETF's shares moving back in line with its underlying value. [Emphasis added]” (SEC “Investor Bulletin: Exchange Traded Funds (ETFs)”, p. 3.)

Authorized participants are typically banks and large broker dealers which position themselves between investors and vehicles relating to electronic trading price data streams and the electronic trading of interests (or shares). Because authorized participants have a monopoly on transacting directly with an ETF (the primary market), all other traders are restricted to transacting ETFs in the secondary market. If a vehicle's interests become mispriced relative to its positions, or excess latency develops in the price data stream of vehicle interests relative to vehicle positions, only an authorized participant can transact with both the vehicle and its assets to remedy the adverse condition. Further, even though it is the beneficial owners of interests who are disadvantaged by errors and latency in electronic trading, it is the authorized participants who reap the benefits even though there's no affirmative obligation for the authorized participants to perform. Known interests and systems rely on classic academic theories of arbitrage, rational economic actor theory, and the efficient market hypothesis. As market conditions have expanded in complexity, and market venues and market making have become more fragmented and opportunistically oriented, new technologies are required.

Blackrock, one of the largest sponsors of fund products in the U.S. published a March 2017 whitepaper entitled “A Primer on ETF Primary Trading and the Role of Authorized Participants” (https://www.blackrock.com/corporate/en-at/literature/whitepaper/viewpoint-etf-primary-trading-role-of-authorized-participants-march-2017.pdf). The whitepaper details how a fund's electronic trading is reliant on a combination of authorized participant arrangements and loose economic theories. From the “Key Observations” on page one of the Blackrock whitepaper:
“ . . . investors trade shares in ETFs on an exchange, and do not interact directly with the ETF or its sponsor”
“When the ETF share price trades at a premium or a discount to the value of the securities held by the ETF, there is generally an economic incentive for creation or redemption, which is facilitated by an AP (authorized participant) on behalf of a market maker.”
“In the event an AP steps back, other active or inactive APs may seize upon the opportunity to interact with that ETF, although there is no obligation to do so.[emphasis added]”
“If no AP steps in, the ETF may trade like a closed-end fund and at a higher premium or a discount to the net asset value of the fund . . . until an AP chooses to become active in the ETF shares.”

Also from the white paper on page 3, Blackrock writes “APs do not receive compensation from the ETF sponsor and have no legal obligation to create or redeem the ETF's shares. [Emphasis added]”. The reliance of known systems, and their sole reliance on unrelated-party opportunistic arbitrage, does not take advantage of computerized technological solutions or automated systems directed to benefit real owners.

Most electronic trading and financial instrument data systems are subject to exogenous shocks where the reactions of large numbers of individual actors can result in unexpected conditions and unpredictable outcomes. The independent actors populating an electronic trading system make individual transaction decisions which appear rational and measured based on their individual perspective and information set. However, the interactions and cumulative impact of innumerable independent actors can overwhelm or confound an electronic trading system where the aggregation of seemingly measurable individual actions results in outcomes which exceed system parameters and statistical predictability; these aggregating outcomes can drive electronic trading systems transactions away from equilibrium and into bubbles, crashes, and other undesirable boundary outcomes.

Despite widespread belief, the electronic trading of collective investment vehicles differs from the electronic trading of conventional (or first order) securities. Collective vehicles such as ETFs are an amalgamation of individual instruments which transact independently from their underlying constituents. The electronic trading price of the shares of Apple Computer (ticker AAPL) or Microsoft Corporation (ticker MSFT) is a combination of fundamental analysis, technical analysis, comparative analysis, and supply/demand conditions; however, whatever price is observed for a single stock (assuming markets are presenting sufficiently liquid two-way electronic trading prices) may be deemed to be the “fair” or accurate price, because there is no primary/secondary limitation condition and no aggregation of (other) prices. In contrast, an ETF has two “prices” or values: (i) the price observed in the secondary market for the ETF interests in an internet price data stream, and (ii) the value (or intrinsic price) based on the sum of the prices of its constituent parts which is generally challenging for investors to observe on a real-time basis (because of vast amounts of data and latency) and never actionable (except for the small number of agents acting as authorized participants).

Thus, there still remains a need in the art for a system and method to address the deficiencies described above.

### SUMMARY

The disclosed embodiment addresses the deficiencies in the interests of collective vehicles, their electronic trading, and the stored and distributed electronic data stream of values and prices and provides many more advantages over current systems and processes. Among other things described herein, the disclosed embodiment improves accuracy, speed, cost efficiency, and fairness. The disclosed system and related computer readable media may be functionally interposed between an electronic exchange and an internet linked data stream for purposes including increased speed, reduced transaction cycles, improved accuracy and properly directed results in electronic trading data environments independent of hedging or risk management activities or conditions.

In contrast to current systems and methods that attempt to address industry issues outlined above, the disclosed embodiment system and subroutines do not engage in risk management or hedging. The system processes measure, monitor, select process actions, and reevaluate measurements and process actions independent of risk management or hedging. The system processes are immune as to whether a collective vehicle or other measured arrangement is tracking its index or handling its downside risk. Rather the system and process of the present invention operates over discordant electronic trading prices (polled from at least one internet price data stream) and treats measured differentials as a problem of public policy, exchange operation, and relative fairness. Different from hedging or risk management, the system operations treat measured differentials as electronic market data errors, and seek to cure those errors for the purposes of equitable fairness, independent of hedging.

For example differentials between so-called intrinsic values (a kind of appraisal of a collective vehicle) and electronic trading values almost always disadvantage smaller and non-professional traders, and can present opportunities for them to be exploited by arbitrageurs and other professionals. The disclosed embodiment does not care how or why a collective vehicle has assembled its positions, but rather it seeks to remedy the data error existing in electronic trading data streams through specialized computerized processes operating in multiple modes to measure and cure the data error(s) in the fewest number of transaction cycles and at the lowest cost to real owners; real owners are distinguished from electronic market makers and arbitrageurs in that their ownership of collective vehicle interests is not established in the context of market making or arbitraging.

One objective of the disclosed embodiment is to employ software, systems, and processes to close the gap between a collective vehicle's two values which makes electronic trading prices for collective vehicle interests more accurate, and it makes the electronic trading of the interests more efficient. There are additional objectives described herein.

The disclosed embodiment is not limited by the constraints of known methods where the speed and accuracy at which a vehicle reaches equilibrium electronic trading levels is largely dependent on the trades of unrelated and opportunistic authorized participants. Equilibrium is characterized as that condition where the interests (or certificated interests) of a collective vehicle have an aggregate trading value (the product of an electronic trading price and the number of outstanding individual interests or certificated interests) equal to the net asset value of all of the vehicle's positions. Known systems rely solely on the activities of unrelated authorized participants to engage in opportunistic arbitrage activities where the relative richer of the interests or positions are sold, simultaneous with the cheaper of the positions or interests being purchased; known methods require these activities to occur continuously and simultaneously across thousands of disparate ETF and ETF-like vehicles and their interests.

The disclosed embodiment does not include or invoke a hedging process, or other processes of risk management. Hedging and risk management activities and processes for and around collective vehicles operate at the market close (and sometimes the market open) of each market session, and hedging and risk management activities are invoked to cause a vehicle to follow a particular strategy or index. The disclosed embodiment engages in intra-session and post-session data storage and intra-session electronic exchange processes which are independent from and not reliant on the presence or absence of any hedging or risk management activities. Further, the system processes and operations are not correlated with degrees of hedging or risk management; instead the system is functionally interposed in the electronic data and electronic trading environments to supplement, automate, replace, or improve (or any combination thereof) the data and electronic exchange activities engaged in by independent agents such as APs.

Referring briefly to FIG. 5, FIG. 5 illustrates an authorized participant opportunistic arbitrage when a vehicle is in a discount condition (the aggregate value of the positions exceeds the aggregate value of the interests as measured by prices reported on one or more electronic trading venues). In FIG. 5, the beneficial owners or investor (IN) are located at 10, the authorized participant or intermediate dealer (ID) is located at 15, the collective vehicle (C) is located at 13, and the market (M) or electronic trading venue is located at 12. Beginning at electronic trade 51, the ID acquires certificated interests (CI) for cash of 0.9 from IN. Moving to electronic trade 55; ID delivers the certificated interests (CI) in exchange for receiving the vehicle assets (VA) from the vehicle (C). Lastly, moving to electronic trade 53, the ID sells vehicle assets (VA) for cash of 1.0 from M.

It should be noted, depending on the implementation, that the electronic trades illustrated at 51, 53, and 55 are typically executed simultaneously or near simultaneously, and that the sale at 53 is often executed as a short sale (because of transaction reordering or delayed settlements) where ID doesn't yet own the vehicle assets, but expects to acquire them in this sequence of transactions. It is noted that ID has no final position in either the certificated interests (CI) or the vehicle assets (VA); certificated interests have been delivered to the fund (F), and vehicle assets are delivered to the market (M). Taken together, FIG. 5 illustrates a discount condition arbitrage which is hoped to be performed by an authorized participant. The incentive for the authorized participant is the 0.1 differential s/he keeps which is the positive difference between the 1.0 received from the market (M) and the 0.9 paid to the investors (IN). Known methods assume that the inaccurate pricing and trading will be cured by a sufficiently large amount of FIG. 5 transactions; the FIG. 5 transactions are assumed to repeat until the 0.1 differential between the interests and vehicle assets narrows to zero (i.e. the arbitrage condition has been exhausted).

Relating to the benefits of the disclosed embodiment, it is noted that known methods rely on an authorized participant identifying the discount condition in a timely manner, and an authorized participant executing all of the electronic trading steps without undue delay. Further, it should be noted that beneficial (or real) owners only received the problematic low and inaccurate electronic trading price of 0.9 (FIG. 5, at 51) while the known system results in the authorized participant intermediary keeping the 0.1 differential. The monitoring of the differential condition is subject to the uncontrollable diligence of unrelated third party intermediaries, and if the unrelated third party intermediaries don't transact quickly, electronic trading values can remain inaccurate for an indefinite period of time.

Referring briefly to FIG. 6, FIG. 6 illustrates an authorized participant opportunistic arbitrage when a vehicle is in a premium condition (the aggregate value of the interests exceeds the aggregate value of the positions as measured by prices reported on one or more electronic trading venues). In FIG. 6, the beneficial owners or investor (IN) are located at 10, the authorized participant or intermediate dealer (ID) is located at 15, the collective vehicle (C) is located at 13, and the market (M) or electronic trading venue is located at 12. Beginning at electronic transaction 61, the ID distributes certificated interests (CI) for cash of 1.1 to IN. Moving to 63; the ID acquires vehicle assets (VA) for cash of 1.0 from M. It should be noted that the steps illustrated at 61 and 63 are typically executed simultaneously or near simultaneously, and that the disposition at 61 is often executed as a short sale where ID doesn't yet own the certificated interests, but expects to acquire them in this sequence of transactions. Finally at 65, ID delivers the vehicle assets (VA) in exchange for receiving the certificated interests (CI). It can be noted that ID has no final position in either the certificated interests (CI) or the vehicle assets (VA); vehicle assets have been delivered to the vehicle (C), and certificated interests are delivered to the investor (IN). Taken together, FIG. 6 illustrates a premium condition arbitrage which is hoped to be performed by an authorized participant. The incentive for the authorized participant is the 0.1 differential s/he keeps which is the positive difference between the 1.1 received from the investor (IN) and the 1.0 paid to the market (M).

In known methods, it is noted that the processes rely on an authorized participant identifying the premium condition in a timely manner, and an authorized participant executing all of the electronic trading steps without delay. Further, it should be noted that beneficial (or real) owners actually paid the excessively high and inaccurate electronic trading price of 1.1 (in FIG. 6), and the known system results in an authorized participant intermediary keeping the 0.1 differential. The monitoring of the differential condition is subject to the uncontrollable diligence of unrelated third party intermediaries, and if the unrelated third party intermediaries don't transact quickly, electronic trading values can remain in an inaccurate state for an indefinite period of time. Further, in known systems, assuming that unrelated third party transactions occur to address the premium condition, many beneficial holders of the certificated interest will affirmatively receive (or pay) the incorrect price.

The electronic trading of crypto-assets including crypto-currencies also have problems relating to a dependence on unrelated intermediary participation. In blockchain and similar electronic trading regimes, not only are intermediaries expected to create timely and accurate pricing data for electronic trading systems, but where transaction ledgers are distributed (i.e. not managed by a central financial intermediary, central clearing entity, or exchange) constant and accurate engagement by unrelated intermediaries is required to confirm all electronic transactions and the very existence of electronically held positions. In a May 17, 2017 Financial Times article entitled “The Currency of the future has a settlement problem”, the author writes:
“Transactions which fail to get the attention of miners sit in limbo until they drop out. But the suspended state leaves payers entirely helpless. They can't risk resending the transaction, in case the original one does clear eventually. They can't recall the original one either. Once source says he's had a significant sized transaction waiting to be settled for two weeks.” [https://ftalphaville.ft.com/2017/05/17/2188961/the-currency-of-the-future-has-a-settlement-problem/]

The third-party intermediaries in the electronic trading systems of crypto-assets (including crypto-currencies) are typically reliant on combination of trading margins and prospective gains from so-called electronic mining operations to serve their roles which are critical to owners and traders. The systems and processes of the disclosed embodiment both supplement and substitute for the otherwise necessary involvement of unrelated intermediaries whose critical roles in electronic data, trading, and settlement are entered into and conducted opportunistically. For the certain purposes of disclosed embodiment, a particular class of crypto-asset or crypto-currency can be analogized to an individual collective vehicle.

Briefly referring to FIG. 4A, in a typical collective vehicle environment there are many intermediary entities between an investor (IN) 10 and a collective vehicle's positions (P) 14. When electronic trading dislocations or electronic trading data errors occur, investors will be adversely impacted and intermediaries are expected to exploit the dislocations or errors. Known methods require waiting for the arbitrage spirits of intermediaries to intervene which is known to cause latency problems in internet price datasets, official data streams, and electronic trading executions. Additionally, known methods are based on directing the value differentials to opportunistic intermediaries rather than the beneficial holders (or real owners) of the interests. In contrast, the disclosed embodiment is directed at curing both system latency and electronic trading price errors, all while directing the benefits of accuracy to real owners rather than opportunistic arbitrageurs.

Prior to the disclosed embodiment, technological change has not been advanced in this area of electronic price and trading data processing, related electronic executions, and real-time vehicle modifications. Typically, parties engaged in the electronic trading of the interests of a vehicle assume that price levels presented in the internet data stream are correct, and the parties relegated to the secondary market will often have little actionable insight into the systematic relationship between value levels of the interests and value levels of the positions. Data and price errors relating to discount positions can suppress electronic selling and trap interest holders (and most specifically real owners) desirous of an exit. Data and price errors relating to premium conditions result in investor purchases at erroneous prices, creating near-term losses regardless of market performance. Because known systems are opaque and reliant solely on market forces and the arbitrage spirits of independent actors, electronic trading may occur at incorrect prices and even incorrect directions; wrong data prices produce signals which encourage or cause electronic trades in the wrong direction.

The disclosed embodiment has a number of public policy benefits which improve the function of the electronic trading of collective vehicle interests where the benefits of improved accuracy, latency, performance, and cost accrues to the public including individual investors and public institutions. Known systems do not take advantage of new technologies, and their reliance on the interplay between classical economic theory and an assumed consistent diligence of independent economic actors jeopardizes performance and directs the benefits of any corrective activities to financial intermediaries.

Any combination and/or permutation of the embodiments and objects described are envisioned and within the scope of the invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE FIGURES

FIG. 1 is a diagram which depicts a combination and arrangement of components and relative positioning of systems with positioning and linkages of systems of one of the disclosed embodiment;

FIG. 2 is a diagram having some common elements of FIG. 1 and summarizes positioning and interactions of systems, processors, and computer readable media with both static and live internet electronic exchange linked data streams;

FIG. 3A is a diagram which illustrates the system's equilibrium measurement of the sum-product of interest counts and the interest electronic trading prices, and the mixed sum-product of vehicle positions and the position's electronic trading prices;

FIG. 3B is a diagram and variation of FIG. 3A where the sum-product relating to the positions exceeds that relating to the interests which is commonly referred to as a discount condition;

FIG. 3C is a diagram and variation of FIG. 3A where the sum-product relating to the interests exceeds that relating to the positions which is commonly referred to as a premium condition;

FIG. 4A is a schematic diagram with some common elements of FIG. 1, and illustrates method component parts, linkages, and relative positioning that are arranged differently than FIG. 1;

FIG. 4B is a diagram which depicts with some common elements of FIG. 1, and relative positioning of systems where components and linkages are grouped to distinguish electronic primary market linkages and electronic secondary market linkages that are arranged differently than FIG. 1;

FIG. 5 is a diagram which illustrates the components with some common elements of FIG. 1 and steps of a system where internet price datasets and electronic trading quotation data has indicated a discount condition;

FIG. 6 is a diagram which illustrates components with some common elements of FIG. 1 and steps of a system where internet price datasets and electronic trading quotation data has indicated a premium condition;

FIG. 7 is a diagram which depicts the constituent elements of an electronically traded collective vehicle, a discount condition, and targeted disclosed embodiment outcomes;

FIG. 8 is an expansion of FIG. 7 that depicts constituent elements of an electronically traded collective vehicle, a premium condition, and targeted disclosed embodiment outcomes;

FIG. 9 is a table that lists current authorized participants for SPDR ETFs;

FIG. 10A is a graph which illustrates an example of boundaries of electronic data stream values of a certificated interest that triggers system modification processes during an electronic trading market session;

FIG. 10B is a graph which illustrates an example of an implementation of the disclosed embodiment in FIG. 1 where electronic trading values of an interest are targeted to align with an index value by reference to absolute values, relative percentage changes, or both;

FIG. 11A is a graph which illustrates an example of the system in FIG. 1 ability to measure the responsiveness of certificated interest electronic trading prices for a given size modification for a particular collective investment vehicle in a particular setting for use in dynamic machine learning where the measurements, modifications, and re-measurements provide the system with predicative ability;

FIG. 11B is a graph which illustrates an example of the system in FIG. 1 use of linear approximation in a mode of selecting both a sub-process and order of magnitude of a sub-process in an automated action;

FIG. 11C is a graph which illustrates an example where the disclosed embodiment in FIG. 1 utilizes a technique seeking an equilibrium outcome and accurate data reporting where system responsiveness requires a non-linear predictive response;

FIG. 12 is a flow diagram which summarizes an example of the steps and components of the system and processes of FIG. 1 to measure differentials between the vehicle interests and vehicle positions along with the system outcomes which modify the certificated interest data and certificated interests to improve efficiency, decrease transaction cycles and transaction counts, and increase responsiveness relating to measured differentials.

FIG. 13 is a flow diagram which illustrates an example of the system in FIG. 1 for looped simultaneous and conditional electronic trading market execution of vehicle interests and vehicle positions.

FIG. 14 is a flow diagram which illustrates an example of the system in FIG. 1 for looped and conditional electronic dispositions in connection with interest modification; and

FIG. 15 is an example of a schematic diagram which depicts the internet and network connectivity of the system hardware and system non-transitory computer media of FIG. 1 to internet linked nodes for the purpose of improved accuracy of electronic exchange data and electronic transactions with fewer transaction cycles, reduced costs, and redirected differentials.

### DETAILED DESCRIPTION

The disclosed embodiment's systems perform simultaneous operations which, in differing implementations, will comprise processes with subroutines to: (i) monitor for differentials in internet disseminated electronic trading data streams, (ii) select at least one integrated system solution to decrease or eliminate identified differentials in a minimum of monitoring and transacting cycles, (iii) automatically execute electronic transactions, (iv) execute storage, measurement, and machine learning subroutines, (v) correct and modify the data and parameters of collective interests, (vi) disseminate data relating to system processes in order to retain the secondary market electronic trading benefits of known systems, and (vii) introduce the unique and necessary improvements which reduce latency, electronic trading cycles, costs, errors, and fairness.

Relating to disclosed embodiment systems connectivity, communication links are preferable data links. Data links can alternatively be, but are not limited to, electronic data links, optical fiber connections, wireless data connections, microwave data transmissions, or other available connections used for data transfer for example, over the internet as an email, text message, instant message, FTP transmission and the like. Depending upon the implementation, communication links can operate in one or more modes of transmission. For example, such modes include radio frequency transmissions, optical transmissions, microwave transmissions, or other available data transmission.

The specialized financial system and processes may include a specialized machine such as a server. The server depicts a network, machine computer, processor in communication with or including an image storage/retrieval system or a database of content as described herein. The server, when specifically operating in accordance with the principles of the disclosed embodiment operates as a receiver, translator, processor, filter, storage, and distributor of content related data. The server receives content from content providers, and responds to requests, electronic trading order flows, and administrator settings. The server automatically processes data relating to the system modification of certificated interests. The server may be independent such as an off-site server, or its components and features may be incorporated into a computer site or into features offered by the present invention.

As described further below, the system produces direct responsiveness and transformation between the certificated interests and the vehicle positions through an electronically controlled data linkage which both circumvents the primary market barrier and redirects the value of error conditions through electronic links. The novel system linking interests and positions across the secondary market barrier is not reliant on unrelated third parties and can therefor produce faster and more accurate data production and electronic trading. In addition to decreasing the number of transaction cycles and more quickly realizing stable and robust accuracy in an electronic trading system, the disclosed embodiment introduces a novel and needed safety value to known systems, which can become unstable when failed or erroneously valued electronic trades propagate awaiting an independent and unrelated arbitrageur.

The system and processes monitor, and modify the certificated interests of an electronically tradable collective vehicle along with and the related publicly disseminated data. An electronically tradable vehicle typically holds or links to one or more positions for the purpose of following an index or strategy. The certificated interests of collective vehicles are fractional subsets recorded on at least one distributed, decentralized or centralized electronic ledger, and are transacted electronically over one or more internet-linked electronic trading venues. The system actively monitors and responds to the endogenous items and exogenous factors relating to an electronically traded collective vehicle including internet-based electronic trading data streams. The systems monitors and modifies certificated interests and electronic trading internet data with recursive processing which actively responds to and modifies data on exchange-linked wired or wireless networks with internet connectivity. Simultaneous with the internet connectivity, real-time monitoring, and the production of internet price data streams, the system actively modifies one or more certificated interests, and the system transmits the modifications over internet systems and centralized databases on a real-time basis for continuous recursive looped processing.

The disclosed embodiment's systems run processes, execute electronic transactions, execute storage protocols, and distribute related electronic data over modification of certificated interests in order to retain the secondary market electronic trading benefits of known systems, and to introduce new and unique and necessary improvements which reduce latency, electronic trading cycles, costs, errors, and lack of fairness.

Further, the disclosed system and related computer readable media, produces a novel solution to a long-standing inequity in collective computer-based vehicles by redirecting some or all of the benefits of variation curative activities to actual holders (or real owners) of a collective computer-based vehicle rather than independent and opportunistic arbitrageurs.

Known electronic trading systems rely on the opportunistic and unpredictable engagement of market makers and authorized participants to avoid inaccurate and dangerous boundary conditions and to re-establish accurate electronic trading prices. Known electronic trading systems are based on longstanding principles and theories of single instrument trading; continuously alert profit seeking actors will find mis-valued and inaccurately priced instruments and enter into transactions which will have the effect of curing inaccuracies. However, relating to the disclosed embodiment, many markets are now dominated by the electronic trading of collective vehicles (such as ETFs), and the known systems have been largely untested in electronic trading environments dominated by electronically tradable collective investment vehicles. During most of the ETF industry's growth, market conditions have been uncharacteristically stable and almost continuously rising. In boundary condition markets, many experts expect market makers to limit their electronic market making resources to individual securities (e.g. single stocks and bonds) and to neglect collective vehicles which are more complex to transact due to their rigorous and timely data requirements. This prospect of abandonment by unrelated third party market makers is a major source of concern to regulators as collective vehicles such as ETFs continue to dominate electronic trading volumes. The disclosed embodiment creates, monitors, and modifies certificated interests and the associated electronic trading data stream to supplement conventional electronic systems in normal times, and the disclosed embodiment engages in automated modifications to prevent damaging electronic trading conditions during stressed times. The disclosed embodiment improves accuracy and access to electronic prices and does so with fewer transactions and at increased speed without a reliance on unrelated opportunistic market maker agents.

The disclosed embodiment monitors for unique types of noise and dislocations in electronic price data streams. Electronically traded markets rely on a primary level of controlled noise where buyers and sellers transmit prices to electronic trading venues in the forms of bids (the prices at which buyers will transact) and asks or offers (the prices at which sellers will transact). Individual securities go through a complex dynamic where bids, offers, relative quantities, order types, and time sequencing all interact to result in a single electronic trading price over which unrelated buyers and sellers will transact. Relating to the disclosed embodiment, collective investment vehicles compound the complexity of getting to successful equilibrium outcomes in electronic trading prices. Because collective investment vehicles can be comprised of dozens, hundreds, or thousands of individual instruments, the aggregating effect of many micro markets (i.e. each individual security) must be reconciled along with the separate market noise of the tradable interests of the collective investment. Further, the electronic trading of the interests of collective vehicles can become an insurmountable problem when micro market electronic prices are changing rapidly; rapidly changing real-time data of a collective vehicle's underlying positions can confound or delay collective vehicle interest prices and price data streams. Independent arbitrage seeking actors are known to abandon the electronic trading of collective vehicle interests in fast moving markets either because their electronic trading systems cannot keep up or because they are concerned about electronic trading price data errors. The disclosed embodiment runs its recursive process continuously without the need for delivery of an extra arbitrage profit to unrelated opportunistic and uncontrollable arbitrageurs (i.e. the toll paid for all known methods relying on authorized participants). Also unique, the system creates first order benefits by achieving accurate electronic prices more quickly with more certainty, and the system creates second order benefits through the direction of dead weight loss inefficiencies to the actual owners (or real owners) of certificated interests rather than unrelated profit-seeking intermediaries.

Even where electronic trading markets are operating in conditions with high volumes and regular record-setting levels, some of the largest and most expert electronic trading market makers are stepping away from their role as an important intermediary. As reported by CNBC in the Jul. 25, 2017 article entitled “Goldman Sachs retreats from ETF lead market making” [https://www.cnbc.com/2017/07/25/goldman-sachs-retreats-from-etf-lead-market-making.html], “Goldman has told fund providers it is scaling back its role as a top lead market maker . . . and has already slashed the number of funds it supports . . . ”, “ . . . relatively high regulatory and other costs of operating as an LMM [lead market maker] prompted the pullback by Goldman, one of the few large banks remaining in that role . . . ”, and “ . . . market making is a technology business as much as a trading enterprise, and involves finding the right price for funds holding dozens of stocks or bonds in a split second while making other trades to manage risk”. There is a need in the industry for automated technological solutions to cure deficiencies and to replace expensive and increasingly scarce manual trading.

The certificated interests are tangible items which are manifested as at least one of: (i) an immobilized interest in book entry form where book entries are stored in non-transitory random access memory (RAM) and accessible through internet or network connections, (ii) physically certificated interests, (iii) tangible interests held in an electronic ledger arrangement in a distributed, decentralized, or centralized electronic ledger, (iv) electronic book entry interests residing on the records of a financial services or technology company, or (v) any full or partial combination thereof. Also, as required by prevailing law or regulation, certificated interests refers to interests which are created as, exchangeable for, or convertible into a deliverable physical certificate or token, an immobilized security instrument, or a dematerialized certificate or token residing on a centralized server or in a physical vault.

The certificated interests are created, monitored, modified and transacted electronically for the purpose of one or more efficient aggregations of one or more underlying positions. The aggregation of positions is done for the purpose of tracking one or more indices or strategies (including complex bundles of positions) into a single electronically tradable certificated interest.

The mathematical investment returns of indices or strategies are usually generated through the process of holding, trading (electronically), and rebalancing a number of underlying positions. The underlying positions can include individual electronically transacted instruments including equities, bonds, futures contracts, swaps, options, currencies and crypto-assets. The collective vehicle and certificated interests distill the resultant return into a single instrument which is electronically tradable over a range of internet connected devices as a single instrument. System processes run in parallel to any risk hedging and risk management processes performed by independent agents or other actors, and system processes are not designed or intended to perform risk hedging or risk management processes.

Because the disclosed embodiment is both self-policing and self-correcting, the disclosed embodiment will expand the feasible set for new types of electronically traded collective investment vehicles; in particular, those fund types which have limited or delayed transparency in their underlying positions. For example, collective vehicles which are characterized as either active-non-transparent or non-transparent are uniquely improved by the disclosed embodiment. In the Securities and Exchange Commission (the “SEC”) May 17, 2016 notice relating to rule SR-NYSEArca-2016-08, the SEC writes:
“In light of the non-transparency of the basket of securities underlying the proposed Funds, the Commission seeks comment on how a broker-dealer authorized participant engaging in creation and redemption activity might fulfill its obligation to maintain a minimum level of net capital in compliance with Rule 15c3-1 under the Act and how such an authorized participant would comply with the books and records requirements of Rules 17a-3 and 17a-4 under the Act. For example, how would an authorized participant that is a broker-dealer apply an appropriate haircut to positions included in the Creation Basket when the authorized participant is unaware of the securities included in the basket? In addition, how would the authorized participant determine an appropriate price for such securities? Moreover, how would such an authorized participant make and keep current the records required under Rule 17a-3, including the daily blotter and daily stock record required under paragraphs (a)(1) and (a)(5), respectively, of that rule? [Emphasis added]” (https://www.sec.gov/rules/sro/nysearca/2016/34-77845.pdf)
   As the SEC release describes, electronic trading and data dissemination of non-transparent fund interests cannot be executed with the required electronic trading speed or accuracy required under classical market assumptions because of the limited transparency into the collective vehicle positions. The disclosed embodiment not only cures the deficiencies in known methods, but also expands the capabilities and types of electronic trading systems which can be implemented.

For clarity of presentation, the numerical examples presented herein do not include customary transaction costs or present the customary interfaces. Among the benefits of the disclosed embodiment is that its implementation can alter the operation and functions of the linked specialized system to transform processes and produce new tangible outputs, while using much of the architecture of known systems including financial exchanges, internet electronic price data systems, registry, and ledger technologies. Where unspecified, customary transaction costs and customary interfaces can be assumed to apply to the disclosed embodiment—however, as described herein, because the types and number of transaction cycles required in known systems is reduced or eliminated, the electronic trading of interests is more efficient with lower latency, more accuracy, lower costs, and increased fairness.

The disclosed embodiment is directed at electronic trading environments where future conditions are unknowable, and where material numbers of independent actors are engaging in electronic trading activities without coordination. Known systems and methods rely on the interactions of unaffiliated actors to control the boundary conditions of electronic trading outcomes. In contrast, the disclosed embodiment operates in universal and unknowable real-world conditions where, regardless of the responsiveness or constructive (or destructive) actions of independent electronic traders, fast equilibrium trading conditions will be created and maintained, and potentially inaccurate electronic price data streams are improved with low latency, more accurate data, and more equitable outcomes, where more equitable outcomes means outcomes where some or all of the introduced accuracy and efficiency benefits owners of interests not engaged in electronic arbitrage in a novel manner generally unavailable in known methods.

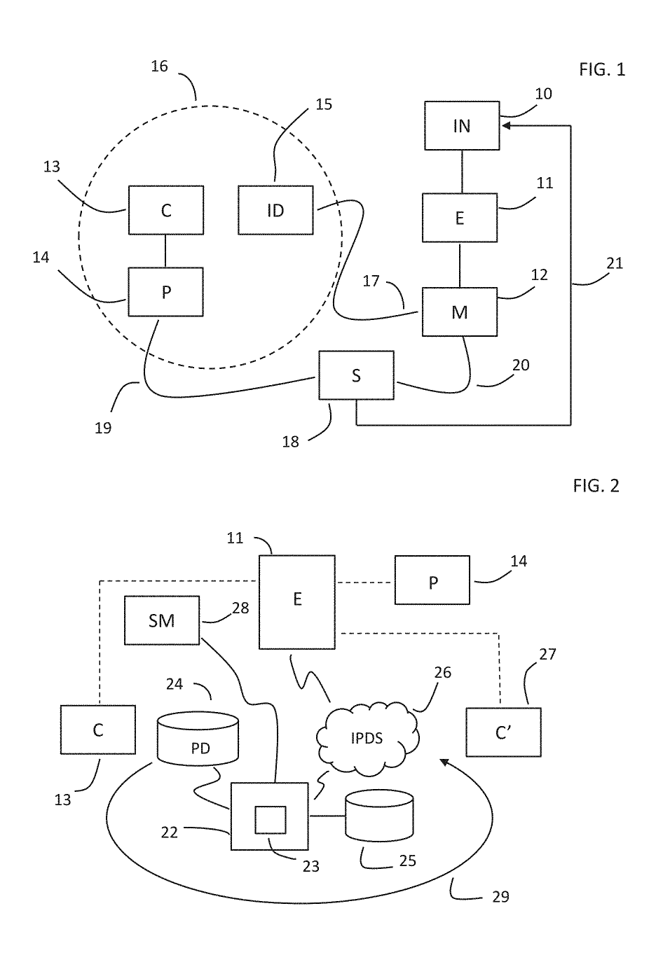

FIG. 1 is a diagram which illustrates the typical connections and arrangements of the component parts in known systems; a novel departure from known system is indicated by position link 19, and interest link 21 which are described below. One or more investors (IN) 10 electronically transact through an exchange (E) 11 into an electronic trading market (M) 12. Separately, a collective vehicle (C) 13 holds positions (P) 14. Critically limiting in known systems, an intermediary dealer (ID) 15 (also commonly referred to as an authorized participant or AP) is the only actor which who can transact in and exchange the positions 14 with the collective vehicle interests at market 12; all electronic transacting links between the market for the collective vehicle 12 and the positions 14, travel through the independent dealer link 17. The primary transaction layer boundary 16, further clarifies that only the independent dealer can electronically transact in, and exchange via an electronic ledger, the positions 14 for the market traded interests 12. The market 12 represents electronic trading venues where interests and positions trade independent of the components of the collective investment vehicle; market 12 is distinguished from exchange 11, in that market 12 encompasses all venues and price discovery outlets, and exchange 11 is an electronic trading portal for a specific item. Any electronic trading price differential which requires remedy through exchange or conversion requires the independent dealer to electronically transact. The investors 10 are far removed from positions 14, and the primary transaction boundary 16 blocks them from any electronic trading or settlement access to the positions 14; further, investors cannot compel independent dealers 15 to independently act to cure inaccuracies, and known methods are entirely reliant on economic theory and the hope that certain market agents including authorized participants will transact.

Continuing with FIG. 1, the limitations in known methods create a condition where the unrelated third party intermediaries 15 have a monopoly on electronic trading relating to the positions, and where accurate data dissemination and accurate electronic trading conditions is entirely reliant on classic economic theory of actors seeking to opportunistically buy low and sell high in what is now an overly complex and often overwhelming blizzard of changing data. Further, commercial conditions have changed where the number and quality of well capitalized actors equipped to both manage the data and capital requirements required to electronically transact along independent dealer link 17 has materially diminished. As a result, material dislocations can persist between the investor's interests and the vehicle positions while waiting for the independent intermediary dealer to notice an arbitrage opportunity and then act on it.

Continuing with FIG. 1, it can be noted that even if the primary transaction boundary 16 were somehow removed, there would still be no way for the investors 10 to access or benefit from a closure of value differentials between the positions 14 and the market 12 without adopting the operating capacity of an independent dealer. The disclosed embodiment improves electronic price data accuracy and removes latencies while also benefiting (directly) the investor 10 without subjecting investor 10 to the customary tolls and costs of the intermediary dealer 15 or forcing regular actors into a complex electronic data seeking arbitrage mode.

Continuing with FIG. 1, the system of the disclosed embodiment is indicated at S 18, with symmetrical networked links to both the positions 14 and the market collective vehicle interests 12. Position link 19 provides the system 18 with data monitoring and electronic transacting capabilities over the positions 14, and market collective vehicle position link 20 provides the system with data monitoring and electronic transacting capabilities over the market data and aggregate collective vehicle data streams at 12; system processes will both store data relating to external links, and time sequenced (or time shifted) extracted data to insure coincidental analysis of internal stored data. Time sequencing (or time shifting) processes will cause all extracted values to be grouped in records or other identifiable time references, such that values are aligned by either a system time clock or timestamps derived from data streams. Further unique to the system, is the novel benefit of increasing equity and fairness, differentials curable by the system operations will be directed to the benefit of actual owners (investors) 10 through differential link 21, rather than accruing for the benefit of opportunistic intermediaries. System 18 will operate in multiple monitoring and curative process action modes independently, uniquely for the benefit of actual owners. In known systems: (i) there is no certainty that the intermediary dealer 15 will perform electronic arbitrage functions, and (ii) if the intermediary dealer 15 performs electronic arbitrage functions relating to differentials between positions 14 and market 12 most or all of the differential will accrue to the benefit of the independent dealer 15 because known systems do not pursue equitable outcomes as a goal.

FIG. 2 summarizes an example of the connections and arrangements between and among the system processor and software and internet-connected processing loops. A continuous and recursive processing loop 29 operates over the parameters database (PD) 24 and the internet price data stream (IPDS) 26. Components of the specialized financial computer system operate the continuous and recursive processing loop 29; depicted components are a processor (and processing node) 23, stored on system RAM 22, software media 28 residing on RAM 22, and a supplemental storage device 25. In continuous monitoring mode, the system continuously compares quotations and transaction prices of the certificated interests to related instruments, positions 14, and indices. The parameters database 24 is monitored and updated by the system continuously, and the parameters database stores the data parameters for the outstanding (and potentially outstanding) certificated interests including some or all of the operative parameters and operational descriptions of the related collective vehicle units. In the FIG. 2 example, the internet price data stream 26 is directly linked to the electronic exchange 11 where it receives real-time and historical electronic transactional data including prices, volumes and timestamps; in practice, the internet price data stream 26 may be transmitted from an intermediary entity, or in the case of a distributed or decentralized exchange, the internet price data stream 26 may have many receiving nodes.

Continuing with FIG. 2, where the processing loop 29 operates in counterclockwise direction and where a modification has occurred, the base condition collective vehicle 13 is modified into the post-processed collective vehicle (or collective-vehicle-prime) (C′) 27. As further described below, known systems do not link the parts for curative action. The internet price data stream is monitored continuously by the system for the purpose of capturing and storing real-time electronic trading quotations (including prices, quantities, and electronic exchange venue detail) and internet stream recorded trades (including time stamp, identity, price, quantities, and settlement); it should be noted that electronic quotations are distinguished from recorded electronic trades in that quotations indicate the current conditions of market quality and accuracy, and the recorded trades indicate the quality and robustness of historical performance. The specialized financial computer system continuously compares quotations and transaction prices of certificated interests to related instruments and indices. Both electronic quotations and electronic transaction prices are monitored on the collective investment vehicle's tradable interests, the collective vehicle positions underlying the interests, and independent indices where applicable.

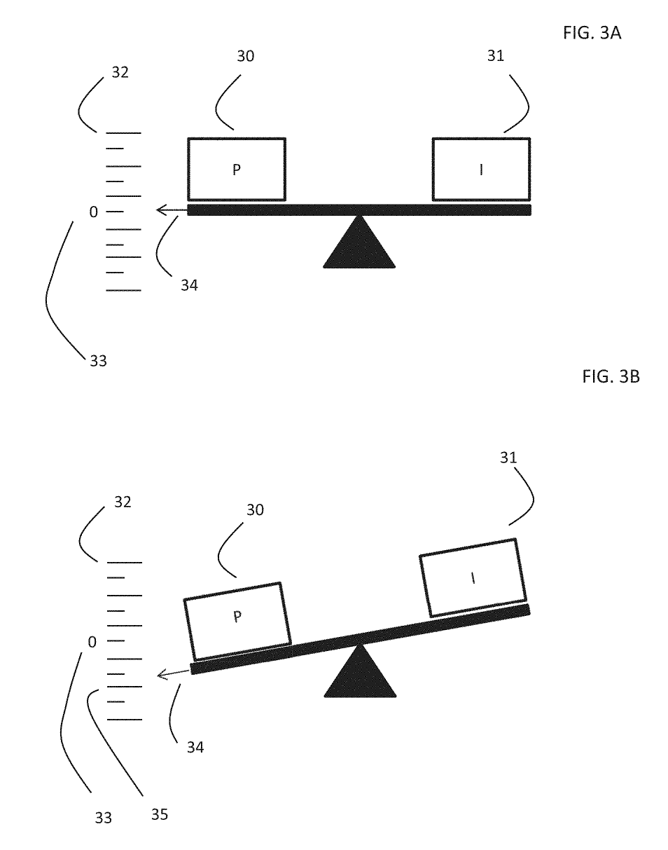

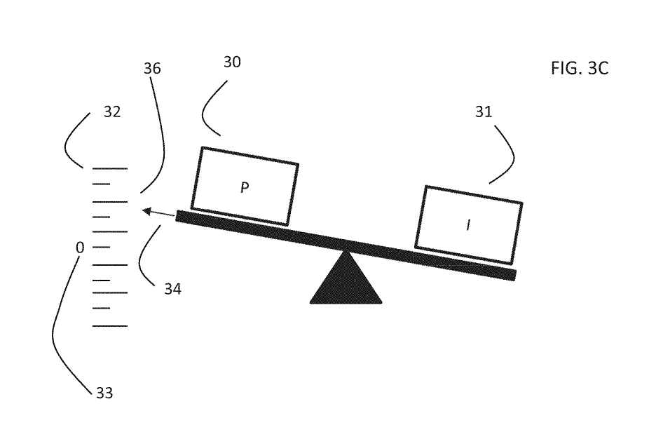

FIGS. 3A, 3B, and 3C illustrate a range of real-world conditions which the disclosed embodiment monitors and reacts to. At all times, the system tests and identifies the condition of certificated interests relative to collective vehicle positions by continuously polling electronic trading price data streams, and modifying the certificated interests directly and indirectly without reliance on third-party intermediaries. Further, the system re-tests the effects of any certificated interests modification, and continuously repeats the process. The unique processes of the disclosed embodiment may run in parallel to any risk hedging and risk management processes performed by other actors, but the system processes are not designed or intended to perform risk hedging or risk management processes. In contrast to risk hedging systems which generally seek to cause or follow a strategy with specific exposure objectives, the disclosed embodiment's objective is to redirect differentials to real owners (rather than opportunistic arbitrageurs) and system processes will operate unimpeded whether a fund is in a hedged or unhedged position with respect to risk management activities. A hedged condition, which is irrelevant for system operations, refers to that condition where the positions of a collective vehicle are of satisfactory composition and in satisfactory proportions to achieve a strategy or minimize an outcome.

FIG. 3A illustrates the system determined equilibrium condition where a system monitored differential is zero. The sum product of certificated interest counts (generally extracted from a parameters or registry database) and certificated interest prices from one or more electronic trading venues (generally extracted from the internet price data stream) is indicated as the aggregate price weighted amount of certificated interests (I) at 31. The sum product of collective vehicle positions (generally polled from an internet distributed data stream disseminated by an exchange, a centralized party, or regulated clearinghouse) and collective vehicle position prices from one or more electronic trading venues (generally from an internet price data stream) is indicated as the aggregate price weighted amount of collective vehicle positions (P) at 30. The differential is indicated on the scale at 32 where a differential of zero is indicated in the middle of the scale at 33; a differential of zero is consistent with an equilibrium condition. A differential premium (or premium condition) is where the aggregate price weighted amount of certificated interests exceeds the aggregate price weighted amount of collective vehicle positions (i.e. the certificated interests are overvalued). A differential discount (or discount condition) is where the aggregate price weighted amount of collective vehicle positions exceeds the aggregate price weighted amount of certificated interests (i.e. the certificated interests are undervalued as measured by prices drawn from the price data stream). It should be noted that the certificated interests and the collective vehicle positions may be a homogeneous or heterogeneous pools of instruments. Data polled and extracted from external sources is stored by the system as internal stored data for use in subsequent process and may be stored for a varying amount of time ranging from one compute cycle to indefinitely depending upon system requirements.

FIG. 3B is a continuation of FIG. 3A where the system has identified a differential discount (or discount condition). Because the aggregate price weighted amount of collective vehicle positions at 30 exceeds the aggregated price weight amount of certificated interests at 31, the indicator at 34 displays a discount or negative result at 35 on the scale 32; the certificated interest's electronic trading prices are lower than their equilibrium level. The discount condition has proved more common than a premium condition, and a discount condition is a particularly serious problem, and it introduces a lack of efficiency for holders of interests. Holders who acquired certificated interests to achieve the performance of the aggregate positions (and the related index or strategy) are underperforming, and holders of the interests who seek near-term liquidity through an electronic trading sale will suffer a loss because the interests are undervalued relative to their intrinsic or correct value. As described below, the disclosed embodiment undertakes a number of automated and system controlled steps to modify its certificated interests to cure the inefficiency faster, with fewer transaction cycles, and with reduced cost compared to known methods. Further the disclosed embodiment produces an important public policy benefit in that the disclosed embodiment produces faster equilibriums where the economic benefit is directed to actual holders (or real owners) of certificated interests rather than arbitrage-seeking brokers and other intermediaries.

FIG. 3C is another continuation of FIG. 3A where the system has identified a differential premium (or premium condition). Because the aggregate price weighted amount of the certificated interests at 31 exceeds the aggregated price weight amount of collective vehicle positions at 30, the indicator at 34 displays a premium and positive result at 36 on the scale 32; the certificated interests electronic trading prices are higher than their equilibrium level. Generally, premium conditions occurs less frequently than discount conditions, and a premium condition creates an inefficiency and accuracy risk where either: (i) under-informed investors purchase electronically traded interests from market professionals at an incorrect and excessively high price (a common occurrence in premium conditions), or (ii) adequately-informed investors seeking to purchase electronically traded interests are precluded from doing so because of a toll from the premium price value. When premium conditions do occur, their order of magnitude is sometimes considerably larger than the size of discount conditions. As in the discount condition, the disclosed embodiment produces an important public policy benefit by reducing or precluding erroneous and inaccurate electronic transactions, enabling accurate electronic trades, and producing faster equilibrium conditions.

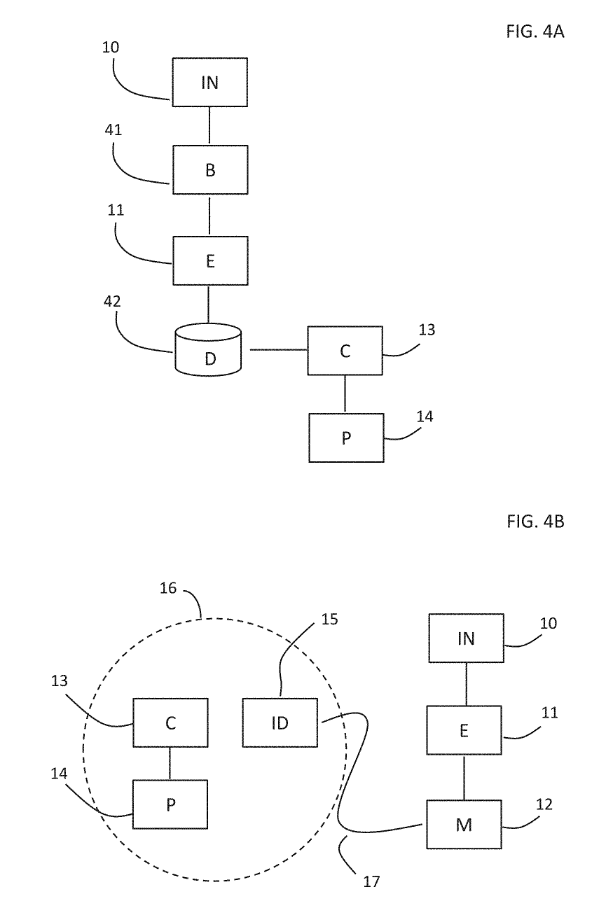

Referring to FIG. 4A, an electronic trading system for collective vehicles is generally comprised of a number of component parts. A collective vehicle (C) 13, holds positions (P or “collective vehicle positions”) at 14; positions P are one or more instruments acquired and held by the collective vehicle for the purpose of tracking an index or strategy. The certificated interests of the collective vehicle are located at depository (D) 42, where a depository may include a physical vault, a secured centralized server accessible through at least one network connection, a validated distributed or decentralized ledger accessible by an internet connection, or the systems of a regulated financial institution with internet and network connectivity, or any combination thereof. The certificated interests are electronically traded and exchanged at exchange (E) 11 where the exchange hosts an electronic trading network with internet connectivity, and where the data for submitted and completed transactions is streamed and/or published through internet connections. The broker (B) at 41 has direct network connectivity to the exchange (E) such that the broker can settle electronic transactions directly with the exchange. Also, the broker can act as direct owner of electronically traded instruments; because the broker has direct settlement capability with the exchange (as contrasted with an individual trader), it often is more efficient for the broker to be the first order owner of interests for more rapid settlement when the individual holder wants to sell. It can be noted that broker (B) 41 may also be an authorized participant in an ETF electronic trading environment. The investor (IN) 10 electronically trades the certificated interests through an internet or network connection with the broker. In certain implementations, the investor may circumvent the broker link and connect directly with the exchange or with the depository; in the case of a direct connection to the depository, the investor may transact directly with other individuals and institutions and the depository may be in the form of a distributed, decentralized, or centralized ledger, and ownership may be effected as an entry in an electronic record or electronic blockchain ledger.

Continuing with FIG. 4A, FIG. 4A depicts the general features of known systems and their forms of connectivity and interests. FIG. 4A and related descriptions are not intended to be limiting as to the components or the arrangements of components; in certain implementations components may be rearranged, substituted or consolidated. Of particular note, and as depicted in FIG. 4A, the investor 10 is often very far removed from the positions 14. Even though the features of known aggregating methods have many benefits, they can also frustrate the electronic trading of the certificated interests, where the accuracy of the certificated interests becomes disconnected from the value of the positions, or where the number of transaction cycles required to align the electronic trading prices of the certificated interest to the electronic trading prices of the positions is excessive resulting in inaccuracy, high costs, and low performance.

Moving to 4B, the figure adds additional organizational and operational detail to FIG. 4A, while carrying over a number of the components for earlier figures including the investors (IN) 10, the exchange (E) 11, the electronic market (M) 12, the collective vehicle (C) 13, and the underlying positions (P) 14. The figure introduces the additional detail of the intermediary dealer (ID) at 15, also commonly referred to as an authorized participant or AP. The market 12 represents electronic trading venues where both interests and positions are electronically valued and traded independent of the collective vehicle; exchange (E) 11 is the electronic trading portal to access market prices. FIG. 4B depicts the primary transaction boundary 16 which illustrates that, not only are investors 10 far removed from positions 14, but a primary transaction boundary also blocks them from any electronic trading or settlement access to the positions 14; investors cannot compel or independently act to cure inaccuracies, and known methods are entirely reliant on economic theory and the hope that certain market agents including authorized participants will transact and that such transactions will result in accuracy. The limitations in known methods create a condition where unrelated third party intermediaries (including authorized participants) have a monopoly on electronic trading relating to the positions, and control over the systems overall accuracy. Material dislocations can persist between the investor's interests and the vehicle positions while waiting for an independent intermediary dealer to notice an arbitrage opportunity and then act on it, thereby decreasing accuracy and fairness.

Referring briefly to FIG. 1, FIG. 1 is contrasted with FIG. 4B in that it depicts an incorporation of the disclosed embodiment which cures both the primary market boundary limitation with a system that creates, monitors, and modifies its certificated units across the primary transaction boundary for benefits which include more accurate electronic trading for investors, and more rapid electronic trading equilibriums. Depiction of the system S at 18 in FIG. 1, introduces components of the disclosed embodiment including the specialized financial computer system which will cure data and electronic trading inaccuracies within computationally irreducible electronic exchange environments otherwise reliant on economic theory and timely engagement of unrelated and uncontrollable independent actors. The system 18 creates a systematic bridge between the positions 14 and the investors 10 through its two pipes; connectivity of the system 18 to the positions 14, and connectivity of the system with the investor 10 (through investor connection 21), where the connectivity, operation and electronic and data plumbing of the disclosed embodiment circumvents conventionally limited architecture, and solves for temporary or permanent lapses in the engagement and efficacy of independent actors. It can be noted that the components and linkages in FIGS. 1 and 4B are not intended to be limiting as to the components or the arrangements of components; in certain implementations components may be rearranged, substituted or consolidated. Operation and processes are detailed below.

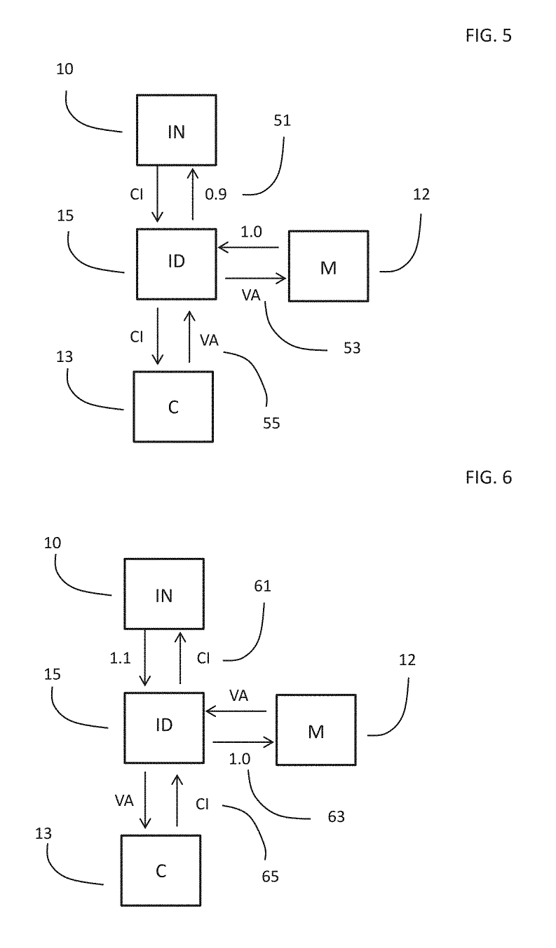

FIG. 5 illustrates the detailed flows of known systems relating to a discount condition similar to the discount condition depicted in FIG. 3B. As detailed below, FIG. 5 depicts a 0.1 per interest discount condition where the electronic trading prices of the interests and the collective investment vehicles positions are 0.9 and 1.0 respectively. It should be noted that the collection of electronic trades depicted in FIG. 5 are believed to produce equilibrium conditions in known methods, however there is no system ensuring that any of the depicted electronic transactions will occur, no system ensuring the engagement of independent arbitrage-seeking actors, and no system assurance that the end result of arbitrage-seeking transactions by authorized participants will achieve a fast or accurate equilibrium. Beginning with electronic trade at 51, the intermediary dealer (ID) 15 acquires certificated interest (CI) from investor (IN) 10 for 0.9 (cash) in a single electronic trade. Moving to electronic trade 55, intermediary dealer (ID) 15 exchanges the newly acquired certificated interest (CI) for vehicle assets (VA) in a single electronic in-kind exchange. Lastly, moving to electronic trade 53, intermediary dealer (ID) 15 trades vehicle assets (VA) for 1.0 (cash). It can be noted that an intermediary dealer, in this example acting as an authorized participant, executed three independent electronic trades.

Continuing with FIG. 5, at the culmination of all electronic transactions, the intermediary dealer (ID) has no instruments, having disposed of the certificated interest (CI) to the collective vehicle (C) and also having disposed of the vehicle assets (VA) to the market (M). Among the three electronic transactions, the intermediary dealer (ID) nets a positive amount of cash equal to 0.1, having paid only 0.9 in transaction 51 and having received 1.0 in transaction 53. It is noted that the discount condition of 0.1 (the absolute difference the electronic trading price of the interest and the vehicle assets) is enjoyed by the intermediary dealer and the investor and holder 10 of the certificated interests received the inaccurate price level of 0.9. Known methods are based on the hopes that: (i) unrelated intermediary dealers will remain continuously vigilant and continuously willing to transact, (ii) electronic markets will anticipate the actions of unrelated intermediary dealers and transact as if they're always the marginal electronic trade (i.e. hoping a premium or discount never occurs), and (iii) if authorized participants intervene and electronically trade some number of interests at the inaccurate discount condition value, the electronic trading price for other units will quickly revert to an accurate equilibrium value—there is, however, no mechanism in known methods to ensure this result.

FIG. 6 illustrates the detailed flows of known systems relating to a premium condition similar to the premium condition depicted in FIG. 3C. As detailed below, FIG. 6 depicts a 0.1 per interest premium condition where the electronic trading prices of the interests and the collective investment vehicles positions are 1.1 and 1.0 respectively. It should be noted that the collection of electronic trades depicted in FIG. 6 are believed to produce equilibrium conditions in known methods, however, similar to FIG. 5, there are no features in known methods which ensure that any of the depicted electronic transactions will occur, and there is no known system assurance that the end result of the arbitrage-seeking transactions by authorized participants (or others) will achieve a fast or accurate equilibrium. Beginning with electronic trade at 61, the intermediary dealer (ID) 15 transmits certificated interest (CI) to investor (IN) 10 for 1.1 (cash) in a single electronic trade. Moving to electronic trade 63, intermediary dealer (ID) 15 acquires vehicle assets (VA) in exchange for 1.0 (cash). Lastly in electronic trade 65, intermediary dealer (ID) 15 exchanges the newly acquired vehicle assets (VA) for certificated interest (CI) in a single electronic in-kind exchange. It can be noted that an intermediary dealer, acting in this example as an authorized participant, executed three independent electronic trades, and that electronic trade 61 may be executed as a short sale (a sale without current ownership) in anticipation of electronic trade 65.

Continuing with FIG. 6, at the culmination of all electronic transactions, the intermediary dealer (ID) has no instruments, having disposed of the certificated interest (CI) to the investor (IN) and also having disposed of the vehicle assets (VA) to the collective vehicle (C). Among the three electronic transactions, the intermediary dealer (ID) nets a positive amount of cash equal to 0.1, having paid only 1.0 in transaction 63 and having received 1.1 in transaction 61. It can be noted that the premium condition of 0.1 (the absolute difference the electronic trading price of the interest and the vehicle assets) is enjoyed by the intermediary dealer, and the investor (IN) and new owner of the certificated interest transacted at the inaccurate price level of 1.1. As in FIG. 5, known methods are based on the hopes that: (i) unrelated intermediary dealers will remain continuously vigilant and continuously willing to transact, (ii) electronic markets will anticipate the actions of unrelated intermediary dealers and transact as if they're always the marginal electronic trade (i.e. hoping a premium or discount never occurs), and (iii) if authorized participants intervene and electronic trade some number of interests at the inaccurate premium condition value, the electronic trading price for other units will quickly revert to an accurate equilibrium value—there is however no mechanism within known methods to ensure this result.

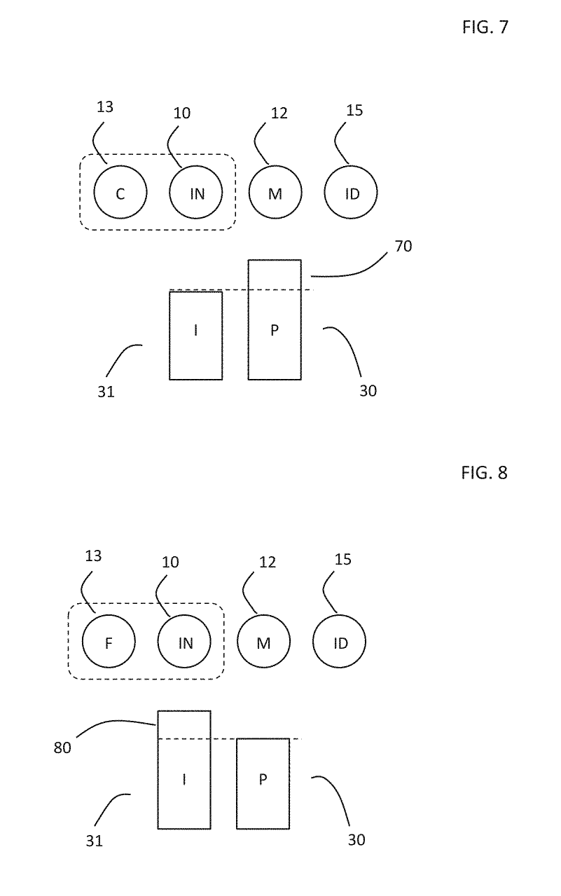

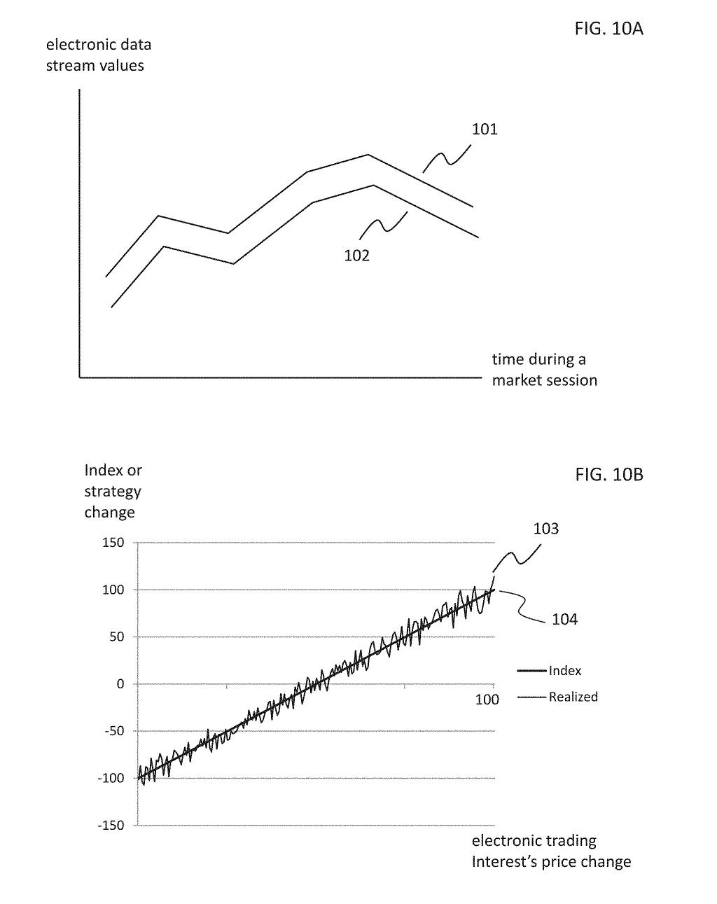

FIG. 7 graphically illustrates and extends the discount condition depicted in FIG. 3B, and it depicts a novel improvement of the disclosed embodiment over known methods. In FIG. 7, the heights of the interests (I) 31 and positions (P) 30 are scaled to indicate their relative aggregate electronic trading values (similar to FIGS. 3A, 3B, and 3C). The discount condition is indicted at 70 and it is the amount by which the electronic trading value of the positions (as measured from values polled from an internet price data stream) exceeds the value of the interests representing the error in an electronic trading data; a dead-weight value loss for all holders of the interests, and a realized loss for a selling holder of an interest. A desirable solution is one which directs the error and dead-weight loss to some combination of the collective vehicle (C) 13 or the investors (IN) 10. Because the investors collectively benefit from all increases in the collective vehicle, the systematic processes of the disclosed embodiment direct discount condition remedies to a combination of the collective vehicle and investors; without the processes of the disclosed embodiment, known methods would siphon gains and value from the rightful owners (the investors or real owners) as a unnecessary toll for the hope that market makers (include independent dealers (ID) 15) provide opportunistic authorized participant activities or related arbitrage activity. In at least one implementation of the disclosed embodiment, the disclosed embodiment operates at threshold boundaries. Referring briefly to the graph of FIG. 10A, lines 101 and 102 illustrate upper and lower boundaries respectively, where the upper and lower boundaries are positioned around electronic trading price equilibrium values, and where the lines 101 and 102 of the system processes will initiate their modification processes, understanding that the monitoring processes are in operation at all times. A boundary conditioned implementation has the benefits of properly incenting authorized participants to engage in narrow arbitrage opportunities with appropriately limited gains, while system processed electronic trading eliminates material data and electronic trading errors and material dead-weight losses.

FIG. 8 is an extension of FIG. 7 and it graphically extends the premium condition depicted in FIG. 3C, and it depicts an important improvement of the disclosed embodiment over known methods. In FIG. 8, the heights of in the interests (I) 31 and positions (P) 30 are scaled to indicate their relative aggregate electronic trading values (similar to FIGS. 3A, 3B, and 3C). The premium condition is indicted at 80 and it is the amount by which the value of the interests exceeds the value of the positions representing an error in an electronic trading system; a dead-weight value cost for all purchasers of the interests. A desirable solution for premium conditions is one which precludes or discourages the propagation of the condition and its resultant error and dead-weight cost.

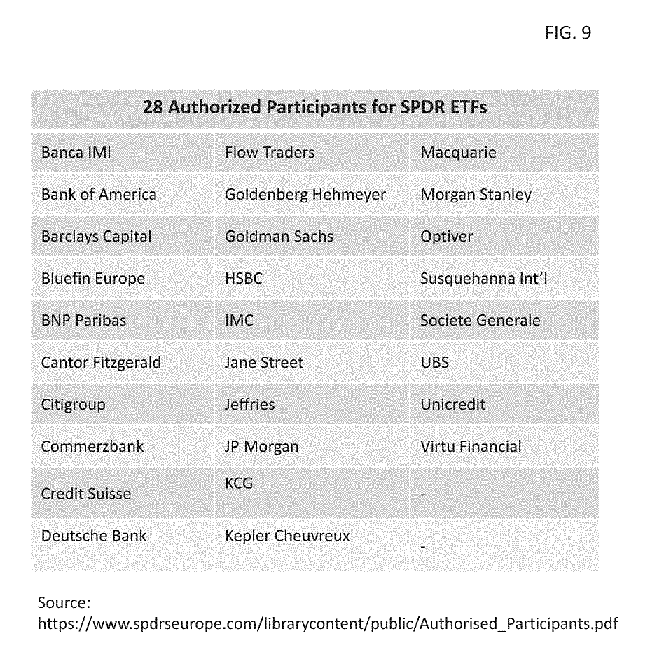

FIG. 9 is a list of the twenty eight authorized participants for the SPDR family of ETFs which is sponsored and administered by State Street Global Advisors which is an operating subsidiary of the State Street Corporation. The participation of the twenty eight authorized participants is touted as a feature of robustness, however, the fact that the sponsor needs twenty eight authorized participations on deck, and the fact that none are contractually bound to act in any capacity to serve the ETFs is of concern. Given that all authorized participant actors will operate opportunistically (and in many respects opposed to the objectives of interest holders), indicates that a large number of unrelated actors is not a substitute for a technological solution which directly solves the inaccuracies in electronic trading independent of hedging or risk management processes.

FIG. 10A graphs the electronic trading price value boundaries of an interest during an electronic market trading session. An upper electronic trading price level boundary is indicated at 101 and a lower electronic price level boundary is indicated at 102. In some implementations, the operation of processes which electronically process and modify the certificated interest's data and parameters may be limited to times in a market session where electronic data prices of the certificated interests are either below the lower boundary 102 or above the upper boundary 101. In the figure, the upper boundary 101 and lower boundary 102 are assumed to follow a path which tracks the intra-session changes in an index or strategy value; it will generally be the case that the vertical distance between upper boundary 101 and lower boundary 102 span the targets or values and that the 101 and 102 boundaries are positioned either symmetrically around a target or values or are positioned asymmetrically to tolerate a higher degree of premium or discount conditions. When the system determines that the electronic trading interest price values are between the boundaries 101 and 102, the electronic trading of the certificated interests would rely on the actions of market makers and authorized participants and not system directed trading or modifications. For the avoidance of doubt, the system operates continuously regardless of the electronic trading price levels of the certificated interests relative to the boundaries; only system modification of the certificated interests is limited to conditions where certificated interest electronic trading prices are either above the upper boundary 101 or below the lower boundary 102. It can be noted that the axis and boundaries depicted in FIG. 10A can be based on absolute values, relative percentages, measured differences, or any combination thereof.

FIG. 10B graphs the relationship between (x) electronic trading interest's price changes, and (y) the value change indicated by an index or strategy through a aggregating sum product of collective vehicle position electronic trading price changes. The graphic displays two lines: (a) a straight line 104 indicated as “Index” which depicts an idealized relationship between interests and vehicle positions as position values range from −100 to +100 as indicated on the y-axis, where there are no deviations, errors, or dead-weight losses in the electronic trading of the interests, and (b) a jagged line 103 indicated as “Realized” which depicts a real-world electronic trading where values almost always deviate from their ideal “Index” line due to a number of factors including material latency of market maker responses (it should be noted that the Realized line 103 of the figure can also be depicted as a scatterplot without any alteration in interpretation). The disclosed embodiment is expected to narrow or collapse the deviations between “Ideal” and “Realized”. Further, in an implementation of the disclosed embodiment where the electronic trading prices of the certificated interests are set to equal the numerical value of the related index, the system can undertake its processes guided by maintaining a minimizing value differential between the two related values through curative processes; known methods are based on measuring relative percentage changes (between the interests and the index or strategy) and not specific interest values which would make this implementation entirely unique. In an example of such an implementation related to bitcoin, the disclosed embodiment uses its monitoring and modification processes to actively redirect the electronic trading price of one or more certificated interests to equal a bitcoin index value through system process action without the need to invoke hedging or risk management (i.e. when bitcoin value equals x, the system will direct the certificated interest electronic trading price to equal x); this example is distinguished from conventional and know systems where relative changes are hoped to align, but no attempt is made to align absolute values of index and certificated index price.

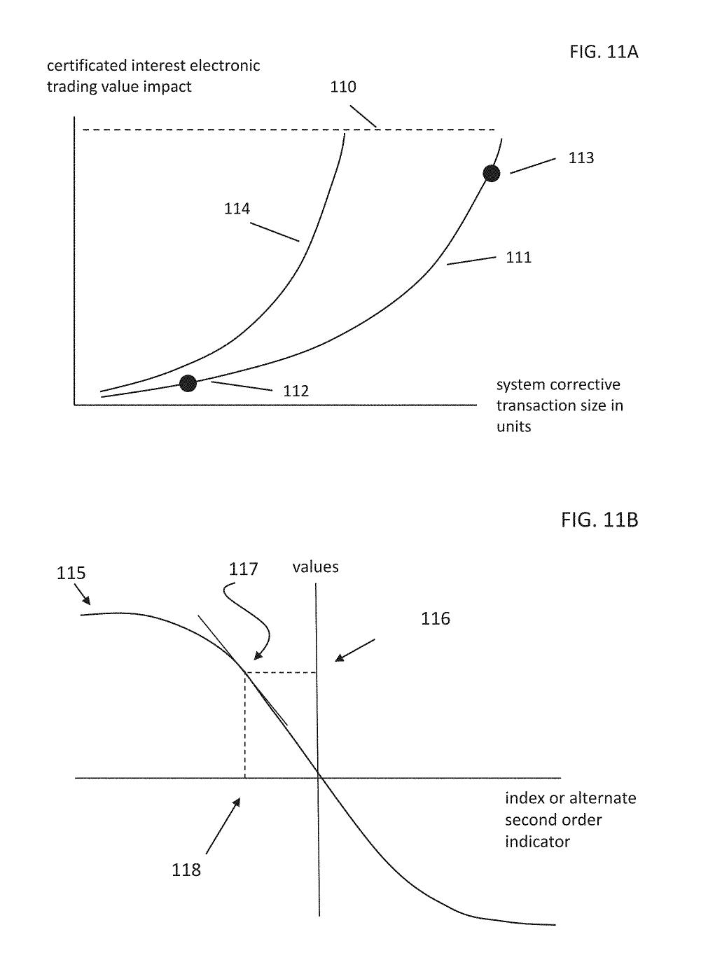

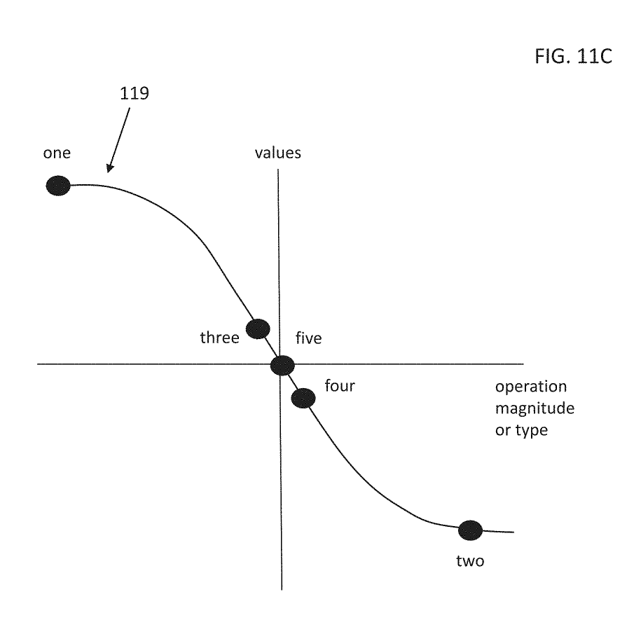

FIG. 11A is a stylized graph which illustrates an example of the basic machine learning of the system as it processes and corrects for certificated interest electronic trading data inaccuracies and deadweight inefficiencies. Equilibrium line 110 indicates that quantity of certificated interests or vehicle positions modified and traded to achieve an equilibrium condition, where the electronic trading price of a certificated interest is equal to its related intrinsic value (point values below equilibrium line 110 indicate insufficient system impact, and points above equilibrium line 110 indicate excess system impact). The x-axis is equal to the number of units (units measured in certificated interests, vehicle positions, or both) transacted by or modified by the system in a single cycle, and the y-axis is equal to the impact of a system cycle on the certificated interests electronic trading price. The curvilinear line 111 indicates the responsiveness of system actions of different sizes (sizes on x-axis) for a single modification cycle for a particular vehicle and particular certificated interest in a specific market condition, and curvilinear line 114 plots the responsiveness of system results in an alternate vehicle, interest, or market condition (it can be noted that, while only two responsive curves are displayed, the system is capable of computing, storing and operating with a large number of responsiveness curves). The data underlying the responsiveness curves is generated and stored by the system based on system modification sizes and electronic trading price results for completed system cycles. The responsiveness line 111 indicates that system responsiveness (i.e. how far have the certificated interest price levels have move toward an equilibrium level for a given system action size in a given context) will generally be non-linear; very small modifications 112 will be expected to have minimal equilibrium impact and large unit amounts 113 will have large equilibrium impact. The system will employ active and dynamically modified machine learning based on the storage and processing of system created and continuously updated and expanded set of responsiveness curves. In the context of machine learning, the system will have the experience of processing modifications on a real-time basis in the context of many different market conditions for many types of vehicles. Experiential cycles and outcomes, stored in the responsiveness curves and other formats are utilized by the system to make predictions about the effectiveness of a given process and action (or process action node) selection and a given modification amount through predictive analysis including linear and non-linear regression prediction measures using formats including the responsiveness curves, cluster analysis using the data points and data lines exhibited at FIG. 10B and related pattern recognition. Predictive analysis data may be stored in a variety of formats including databases, look-up tables, formulas, numerical processes, graphical representations, other data formats, and combinations thereof, and can be collectively also be referred to as stored predictive analysis or stored predictive data analysis in the context of system components. Further predictive analysis may be derived from experiential data derived by the system, administrator inputs; research guided rules, other sources, and combinations thereof, where such combination or combinations are the stored system operational guidance, inclusive of stored experiential data, utilized within system processes.

FIG. 11B is a stylized graph which illustrates another example of the basic machine learning of the system as it processes and corrects for certificated interest electronic trading data inaccuracies and deadweight inefficiencies. FIG. 11B illustrates an example where system machine learning is guided by second-order variables including an index or alternate second-order variables and indicators; the x-axis is the second-order indicator and the y-axis is the value or values of the collective vehicle. Similar to FIG. 11A, the responsiveness curve is generally based on empirical or numerical data gained by the system over time. In the figure example, the system is seeking an equilibrium interest value indicated at 116 when an indicator, index or other measure carries a measurable value illustrated by the sample value at 118. The intersection of response curve at index/indicator value 118 and equilibrium interest value 116 is coincidental with a slope indication 117 of stored response curve 115, where the system has used numerical, closed form or other estimators to compute slope 117, where 117 indicates a slope which is utilized by the system as a responsiveness predictor in order for the system to select a corrective process action and an order of magnitude of the corrective process action. Slope and tangent line 117 is a system generated predictive measure which is utilized by the system to achieve an accelerated equilibrium condition.

FIG. 11C is an extension of FIG. 11B illustrating an example of system generated and accessed responsiveness curves where responsiveness is measured by the operation order of magnitude or type (the x-axis), and the value or values of the collective vehicle are indicated on the y-axis. In FIG. 11C, a non-linear responsiveness line 119 is graphed on the axes. The figure depicts an example of a numerical or Newton Raphson machine learning and solution seeking a solution for an identified differential or non-equilibrium condition. In the figure, the y-axis indicates value (or values) deviation(s) where a solution exists at the intersection of the axes. Similar to the responsiveness data illustrated in FIG. 11B, the non-linear responsiveness curve 119 reflects a collective vehicle in a particular combination of market conditions. In the illustration, the system performs five modifications numbered and labeled one, two, three, four, and five in five transaction process cycles. Further in the example, the system illustrates the operation of a computer based numerical process, where the measured results are indicated on the y-axis. In the figure illustration, the system performs five transactions (which for the avoidance of doubt, may take place at entirely different times, and non-consecutive times, where the collective vehicle and prevailing conditions are however consistent) where the system bounded the order or magnitude or type by executing transactions one, then two, then the system bisected the differences, executing three, then four, then bisected the differences again landing on equilibrium result five. While only one non-linear responsiveness curve 119 is depicted for clarity of presentation, in implementation, a system may develop, aggregate, store, access, and respond to hundreds of responsiveness curves where each is cataloged for specific conditions.

The system learning of the disclosed embodiment is not captured or exploited in known methods. In its machine learning processes the system can rely on a number of response curves including those indicated by FIGS. 11A, 11B, and 11C. In some applications, the data based machine learning responsiveness curves will be supplemented by additional computer processing methods using combinations of techniques on the system stored data including Newton Raphson (or Newton's method), differential calculus, and other numerical estimation methods. The system may also employ other types of storage techniques to achieve similar results including lookup tables, formulas, databases and other relational storage methods.

Unique from known methods, the disclosed embodiment is designed to cure data inaccuracies and improve a wide range of electronic trading environments where the electronic trading environments are unpredictable, unstable, and impacted by hundreds, thousands, or millions of independent economic actors whose actions can flip from heterogeneity to homogeneity in times of stress or uncertainty. While the disclosed embodiment is mechanically compatible with current environments, it uniquely solves for what is otherwise a computationally irreducible problem through its dynamic, recursive and machine learning processes. It can be noted that the stylized graphical depictions are not intended to be limiting as to operations or the arrangement of the components; in certain implementations components may be rearranged, substituted or consolidated.

Referring briefly back to FIG. 10B, the environment in which electronically tradable interests transact is subject to many perturbations and inefficiencies, and perturbations errors and inefficiencies are caused by a number of outside factors and agents which introduce rapid and competing forces which can destabilize equilibriums and introduce electronic trading data inaccuracies. Further, the non-linearity and computationally irreducible of forcing the electronic trading of collective vehicle interests (back) into equilibrium have limited the range of current and known methods to a system of “hope” based on classical economic theories; market participants in collective vehicle electronic markets hope for the actions of natural market forces and unrelated actors to self-regulate a largely intractable environment. In contrast, the disclosed embodiment is a wholly integrated solution in which the system's specially integrated connectivity and processes engage in continuous monitoring and modification in response to all known and unknown forces which destabilize equilibriums and introduce data inaccuracies. In differing implementations, the system is uniquely devised to use its software to repeatedly learn responsiveness, including a self-created subsystem built library of created, stored, and internally analyzed conditional and situationally dependent numerical derivatives to constantly improve the speed which the system reestablishes equilibriums and delivers accurate data streams. In one example of the disclosed embodiment, a measuring, modifying, and re-measuring machine learning system can reliably maintain efficient and accurate electronic trading data and electronic transacting values in collective investment vehicles where two levels of electronic price data (i.e. the vehicle's underlying positions and the vehicle's independently tradable aggregating certificated interests) are subject to divergence and error.

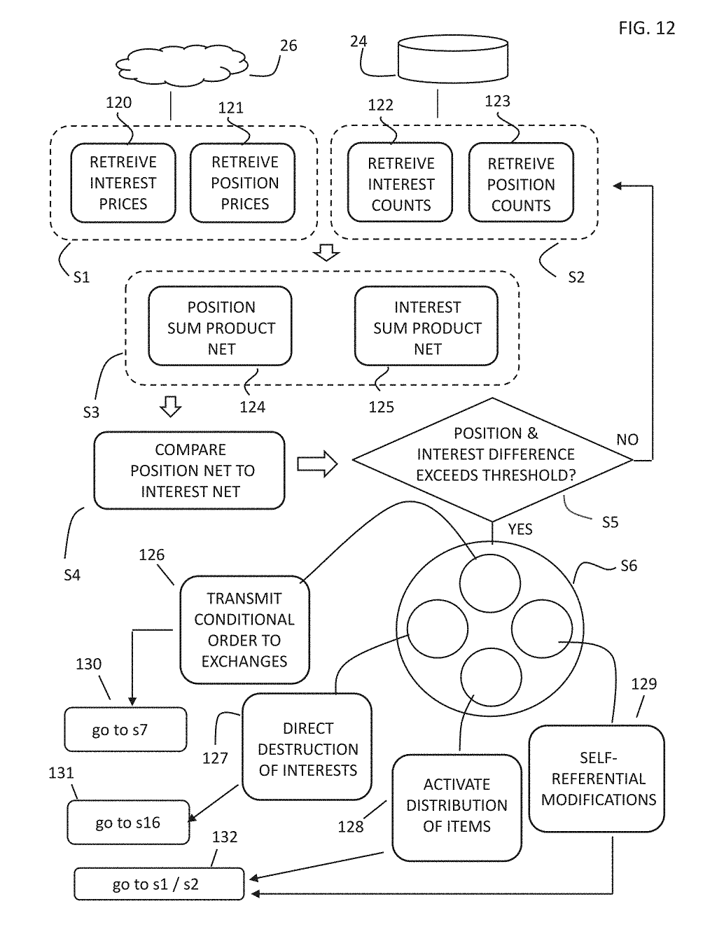

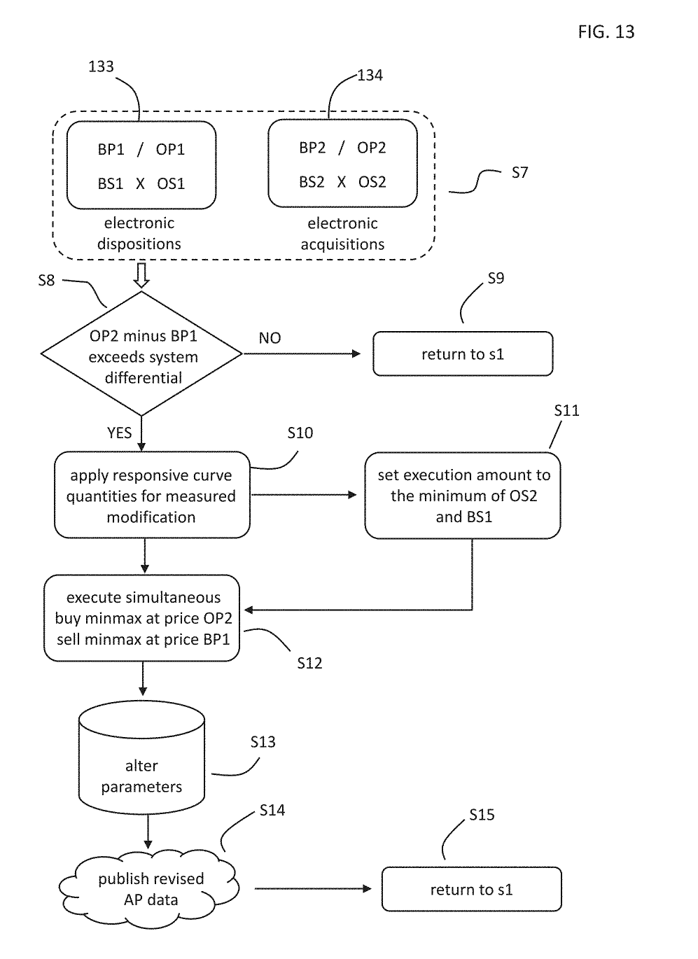

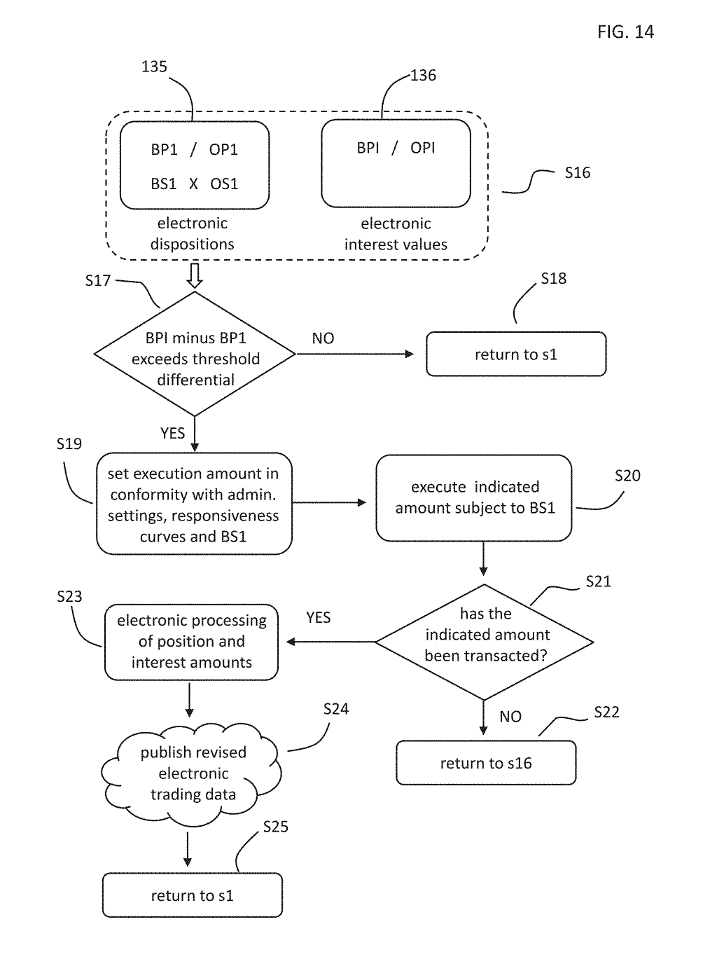

FIG. 12 is a flow diagram of an example implementation. The flow diagram is a summary example of the system data stream monitoring, data stream modification, system directed electronic trading, certificated interest modification, and the related recursive system component interactions. In FIG. 12, it is assumed that some quantity of collective vehicle interests are both trading and linked to disseminated electronic trading data (or a disseminated electronic data stream) on at least one internet price data stream. The system process runs from FIG. 12 step S1 and branches to FIGS. 13 and 14, and repeats beginning again at step S1. The system runs continuously during market sessions, and because the system operates in environments of innumerable independent and unrelated actors (electronic traders including investors, market makers, and authorized participants), actions of the system will alter system data stream readings and market environment conditions. During electronic trading sessions, many of the system sub-steps are capable of cycling many times in one minute.

Continuing with FIG. 12, an example of the disclosed embodiment system steps are approximately grouped as: (a) data retrieval processes at S1 and S2, (b) data analysis and processing processes at S3 and S4, and (c) modification processes of the certificated interests and data at S5 and the steps which follow; it can be noted that these processes are arranged in FIGS. 12, 13 and 14 in a sequential manner, but system operations are effectively parallel and recursive and may be reordered or consolidated in implementation.

Moving to FIG. 12 step S1, the system retrieves certificated interest electronic trading values at 120 and collective vehicle position electronic trading values at 121 from an internet electronic data stream 26; the retrieval of electronic trading data relating to the certificated interests and the positions is performed simultaneously in step S1. For the purposes of step S1, it is assumed that the related system sub-steps have been pre-seeded with necessary tickers, security CUSIPs (Committee on Uniform Security Identification Procedures), and other necessary identifying keys.

At FIG. 12 step S2, the system retrieves custodial data relating to the collective vehicle and its interests. The system retrieves current and limiting certificated interest counts at 122 and the position counts of related instruments held by the collective investment vehicle from the parameters database 24; the retrieval of data from the parameters database relating to the interests and the positions is performed simultaneously in step S2. Certain system modifications to the certificated interests may initiate one of more corporate actions where a modification entails a distribution, tender, split, repurchase or other action for the purpose of reducing any identified electronic data inaccuracies; in addition to storing outstanding quantities, all authorization, filing limitations, and other particulars are stored on the parameters database or in system RAM.

Moving to FIG. 12 steps S3 and S4, the system produces aggregate value weights from the internet price data stream and the parameters database, and the system determines the presence of equilibrium, discount, or premium conditions as illustrated in FIGS. 3A, 3B, and 3C. The sum products of positions 124 and the sum product of interests 125 and generated by the system and stored by system storage components for use in subsequent near-term processing in intra-session steps and for long-term processing in the system's long-term machine learning library of responsiveness curves and evaluative learning.

Moving to FIG. 12 step S5, the system evaluates any differential condition identified in step S4. The system will store and modify at least one certificated interest value and electronic trading data through at least one system modification action which is selected by recursive system processes or directed by an administrator input. As depicted in the upper and lower boundaries of FIG. 10A, where the upper and lower boundaries are assumed to span an equilibrium condition of zero differential, system actions may be restricted in near-equilibrium electronic trading conditions. Where the differential determined in step S4 is below the threshold value, step S5 will indicate “NO” and the system will return to execute steps S1 and S2 (and their related sub-steps). Where the differential determined in step S4 is above the threshold value, step S5 will indicate “YES” and the system will progress to the certificated interest modification selector and data modification at step S6.

FIG. 12, at step S6, illustrates an example of a certificated interest modification selector with four process action nodes; the implementation depicted in FIG. 12 shows four separate process nodes, but other implementations may include a different number of action nodes, or action nodes may be configured, ordered, or arranged differently. The first process node at 126 transmits conditional electronic orders to exchanges or other trading venues. The process node at 127 executes at least one electronic transaction for the direct destruction of certificated interests, where the direct destruction of certificated interests is related to the disposition of one or more collective vehicle positions and a corresponding reduction in certificated interest counts or amounts. The process node at 128 invokes a system distribution of collective vehicle positions including cash and any type of currency. The process node at 129 initiates system self-referential modifications to one or more certificated interests where the certificated interests are modified through a change in one or more parameters, where parameters include spreads, margins, indices, responsiveness, re-denominations, limitations of transacting, or other similar parameters for purposes including changing electronic data. It is noted that in the system modifications at nodes 126 and 127, the system will electronically trade certificated interests, collective vehicle positions, or both certificated interests and collective vehicle positions near simultaneously. Further, it is noted that in the system modifications at nodes 128 and 129, the system will not directly engage in electronic trading of instruments. In differing implementations, the system's modification selector may be arranged in alternate configurations with fewer nodes, additional nodes, or a rearrangement of the processes at each node. It is also contemplated that more advanced implementations allow for combinations of separate process actions to be selected and acted in particular quantities or sequences.

At FIG. 12 process action node 126, the process moves to FIG. 13 step S7. At FIG. 13, step S7 electronic trading data for the system's electronic trading dispositions are indicated at 133, and electronic trading data for the system's electronic trading acquisitions are indicated at 134. The process node 126 conditional order transmission processes the acquisition of at least one interest or position, and the disposition of at least one position or interest; the two states of action are (i) the disposition of one or more underlying positions and the acquisition of one or more interests, and (ii) the disposition of one or more interests and the acquisition of one or more positions for a number of purposes including the altering of the related internet distributed data stream. At electronic dispositions 133, BP1 and OP1 indicate the electronic bid price value and electronic offer price value of instrument 1, where the bid price indicates that electronic trading price level at which an unrelated buyer will purchase instrument 1, and the offer price indicates that electronic trading price level at which an unrelated seller will sell instrument 1, and where instrument 1 is that instrument (certificated interests or one or more underlying collective vehicle positions) subject to system disposition. Continuing with electronic dispositions 133, BS1 and OS1 complement BP1 and OP1 by indicating the respective unit counts (or size) of the respective electronically trading orders, where BS1 is the number of units (or size) an unrelated buyer will accept at price level BP1, and where OS1 is the number of units (or size) an unrelated seller will transact at price level OP1. It is noted that with respect to underlying positions, the electronic trading quotation data may be a composite of a number of positions, quotations, and sizes, and the illustration of 133 represents average, aggregate or a composite values as appropriate. Further, where electronic traders are sequencing their trades in partial sizes (i.e. BS1 and OS1 display smaller sizes than actually available) the activities of step S7 will be repeated.

Moving to electronic acquisitions 134, BP2 and OP2 indicate the electronic bid price value and electronic offer price value of instrument 2, where the bid price indicates that electronic trading price level at which an unrelated buyer will purchase instrument 2, and the offer price indicates that electronic trading price level at which an unrelated seller will sell instrument 2, and where instrument 2 is that instrument (certificated interests or one or more underlying collective vehicle positions) subject to system acquisition. Continuing with electronic acquisitions 134, BS2 and OS2 complement BP2 and OP2 by indicating the respective unit counts of the respective electronically trading orders, where BS2 is the number of units (or size) an unrelated buyer will accept at price level BP2, and where OS2 is the number of units (or size) an unrelated seller will transact at price level OP2. It is noted that with respect to underlying positions, the electronic trading quotation data may be a composite of a number of positions, quotations, and sizes, and the illustration of 131 represents average, aggregate or a composite value as appropriate. Further, where electronic traders are sequencing their trades in partial sizes (i.e. BS2 and OS2 display smaller sizes than actually available) the activities of step S7 will be repeated.

It is noted that the steps S7 through S12 require the simultaneous or near-simultaneous electronic trading execution of both the electronic disposition 133 and the electronic acquisition 134, and as such, disposition and acquisition data retrieval at step S7 is presented as a single system step. For the purposes of steps S7 through S12, simultaneous usually means within seconds or within fractions of seconds, and near-simultaneous means a period of time immeasurable small (in the context of system processes) such that market conditions do not change and market actors do not materially alter existing electronic orders or quotations. As noted above, where either the disposition or acquisition item involves the collective vehicle positions, the values associated with electronic trading prices and volumes is an aggregate or blended value of all of the collective vehicle positions subject to acquisition or disposition. The electronic trading data relating to step S7 is shown as a single item for brevity of presentation.

At FIG. 13, step S8 the system evaluates the absolute difference between OP2 and BP1, which is the differential in the electronic trading price values of the item being disposed (BP1) and the item being acquired (OP2). At step S8, the system is re-measuring the differential identified at steps S4 and S5 from the internet data stream, and a reconfirmation of the differential at step S8 initiates the submission of electronic trading orders. Where the differential as measured from electronic dealing prices measured at S8 is unconfirmed or absent, the system will indicate “NO” and processes will return to FIG. 12 step S1 as indicated at step S9. Where the absolute value of the differential as measured at step S8 is non-zero and directionally consistent with the measurement at step S5, the system will indicate “YES” and prepare and execute electronic trading orders sized based on the system's machine learning limited by available quotation amounts.

Moving to FIG. 13, step S10, the system will both reference those responsiveness curves stored in RAM or other storage media which align with the parameters of the subject vehicle and prevailing market conditions. At step S10, the system will set a maximum amount of system corrective transaction size for electronic trading. Referring briefly to FIG. 11A, the maximum electronic trade size determined at step S10 will be that point on the x-axis were the applicable responsiveness curve (e.g. responsiveness curves 111 or 114) intersect with the equilibrium line 110; the equilibrium line/responsiveness curve intersection may have been learned by the system, and the system may employ a number of numerical and closed-form solution estimates to supplement experiential items.

Moving to FIG. 13, step S11; the system will generate an electronic trade size based on the real-time electronic data quotation stream established in step S7. Because action node 126 entails both a disposition and an acquisition, the system will establish the minimum electronic tradable adjustment limited by the lesser of (i) the bid quantity of the disposition item, or BS1, and (ii) the offer quantity of the acquisition item, or OS2. It is noted that where certificated interests or collective vehicle positions are composed of multiple parts, the quantities represented by BS1 and OS2 and their associated electronic quotation price values means average quotation values, and aggregate quantities, or quantities balanced by vehicle holdings.

Continuing with FIG. 13, step S12, the system executes simultaneous electronic trades in a quantity bounded by the maximum quantities determined in step S10, and a minimum quantities determined in step S11. The executed amounts bounded by the determinations in step S10 and S11, are indicated as “minmax” at step S12. Steps S7 through S12 are processed and executed by the system near simultaneously, where near simultaneously means a short enough duration of time where electronic traders of interests and collective vehicle positions do not materially alter their electronic quotations of bids and offers. Determination of minmax values may be based on different internally determined values used in a similarly bounded manner.

Continuing with FIG. 13 steps S13 and S14, the system alters the parameter registry at step S13 to reflect modifications to the collective investment vehicle and any specific modification to the certificated interest quantity count or quantities; it can be noted that the quantity of the certificated interests will be modified to a higher or lower value following step S12. At step S14, the system operates in a transmission mode, transmitting revised data items across internet linked electronic trading portals and financial exchange data outlets. The system processes then return to step S1 as indicated at step S15, and it is anticipated that in subsequent system cycles running between steps S1 and S4, the electronic trading prices of the certificated interests will have been moved closer to an equilibrium value position.

Referring back to FIG. 12, and processing node 127, processing node at 127 executes at least one electronic transaction for the direct destruction of certificated interests, where the direct destruction of certificated interests is related to the disposition of one or more collective vehicle positions and a corresponding reduction in certificated interest effective amounts. Under process node 127, the system moves to the steps summarized in FIG. 14, and at step S16, the system measures (or re-measures) for a differential in the electronic trading prices of the collective vehicle positions and the certificated interests; in contrast to FIG. 13 and processing node 126, under processing node 127, the system does not engage in the electronic trading of the certificated interests. At step S16, the nomenclature is identical to step S7, except that BPI means the electronic trading bid price of the certificated interest (the per-unit-price unrelated buyers will pay for certificated interests), and OPI means the electronic trading offered price of the certificated interest (the per-unit-price unrelated sellers will sell certificated interests).

Moving to step S17, the system confirms or reconfirms the measured differential of the electronic trading price values between the certificated interest and the collective vehicle positions with reference to BP1 and BPI. Relating to the certificated interests BPI is used in the illustration rather than OPI because a holder's electronic trading exit and mark-to-market is generally guided by the price at which certificated interests can be electronically sold; other implementations may use other price variations including mid-market values. Where the measured or re-measured differential falls below the system threshold (“NO”), the system will restart at step S18 and return back to step S1. Where the measured differential exceeds the threshold (“YES”), the system proceeds to step S19.

Moving to FIG. 14 step S19, the system will reference the responsiveness curves stored in RAM or other storage media which align with the parameters of the subject vehicle and prevailing market conditions, any administrator settings which alter electronic trading disposition size, and the electronic quotation data of BS1. Referring briefly to FIG. 11A, the maximum electronic trade size determined at step S10 will be that point on the x-axis were the applicable responsiveness curve (e.g. responsiveness curves 111 or 114) intersect with the equilibrium line 110; the equilibrium line/responsiveness curve intersection may have been learned by the system, and in the absence of learning, the system may employ an administrator setting or alternative estimate. At step S20, the system will electronically trade that amount derived from the responsive curves, subject to reduction by any administrator setting and further subject to the amount electronically tradable as indicated by a quotation data stream of BS1 values; it is noted that where BS1 values only indicate a portion of the amount actually electronically tradable within a single quotation, the system may aggregate multiple quotations to electronically trade the amount indicated by the system's responsiveness or administrator settings. At step S21, the system will record the success of electronically trading of the indicated disposition. Where the system indicates “NO” at step S22, the system will return to step S16. It can be noted that, if quotations or quantities at step S16 prove erroneous or unavailable over a limited number of sub-cycles, the system will revert back to step S1. Where the system indicates “YES” the system will process all electronic trades including making all necessary modifications to the parameters database and the impact of values and amounts on the certificated interests.

Moving to FIG. 14 step S24, the system operates in a transmission mode, transmitting revised data items across internet linked electronic trading portals and financial exchange data outlets. The system processes data items, including updating any internal databases and storage devices, and then returns to step S1 as indicated at step S25. It is anticipated that in subsequent system cycles running between steps S1 and S4, the electronic trading prices of the certificated interests will have been forced closer to an equilibrium value.

Referring back to FIG. 12 and processing node 128 (within step S6), processing node 128 is contrasted with processing nodes 126 and 127 in that, under processing node 128 the system will not engage in electronic trading of collective vehicle positions or certificated interests. Process node 128 utilizes the magnitude of differentials measured at step S4, and under process node 128, the system will actively process the distributing of items held or issued by the collective vehicle directly or indirectly to beneficial holders or real owners of the certificated interests. Real owners (or real holders) are intended to include those holders which own interests prior to a system operation, and to exclude those holders who flip interests in certain rapid arbitrage transactions; in certain implementations, a real holder includes those holders who appear on or within a registry at certain times.

The distributed items include, for example: (i) currency or cash received from positions held, (ii) physical, book entry, or ledger assets on the custodian registry including cash, in-kind items, and other instruments, (iii) units of the certificated interests, and (iv) other items held or issued by a collective vehicle. The system features of process action node 128 are expected to have a prophylactic effect on differentials. Differentials (as illustrated in FIGS. 3B and 3C) are caused by electronic trading data errors, electronic trading anomalies, or faulty or delayed electronic trading arbitrage activity. Process node 128 is an indirect modification of the certificated interests, and the implementation of the processes under process node 128 are expected to reduce the electronic trading prices of certificated interests in premium conditions and are expected to increase the electronic trading prices of certificated interests in discount conditions. It can be noted that the actual outcomes, as measured by electronic trading prices on one or more internet data streams, may be unpredictable, and such unpredictable or unanticipated responses are a novel part of the systems dynamic and continuous machine learning.

Continuing with FIG. 12 and moving to processing node 129 (within step S6), an example is illustrated where the system directly modifies the certificated interests based on the magnitude of differentials measured at step S4. It is noted that processing node 129 does not invoke any electronic trading by the system (as contrasted with processing nodes 126 and 127), and the system will not engage the indirect modification of the certificated interests through the distribution of items as in action node 128. In processing node 129, the system will directly modify the certificated interests through the alteration of the parameters in the parameters database 24 (or an alternate but functionally similar storage device) where the system modifies or adds at least one of: (i) one or more responsiveness multipliers to an index or instrument where the responsiveness is based on a system stored and operated multiplier, and where the multiplier is stored in the system as one or more real number values (where such multipliers can be positive, negative, or zero), (ii) at least one linear or non-linear factor, variable, or constant which modifies certificated interest intrinsic values and electronic trading prices independent of changes in the index or strategy, (iii) unit counts of at least one certificated interest, where the certificated interests intrinsic value is redenominated over a smaller or larger number of individual units, and (iv) an operative parameter which alters an electronic trading value. In the systems of known methods, responsiveness of collective vehicle interests is reliant on the continuous and diligent arbitrage activities of unrelated traders. In contrast, the disclosed embodiment has the capabilities to learn, direct, and execute modifications to the certificated interests to improve the accuracy of electronic trading and to accelerate the time to equilibrium value conditions.

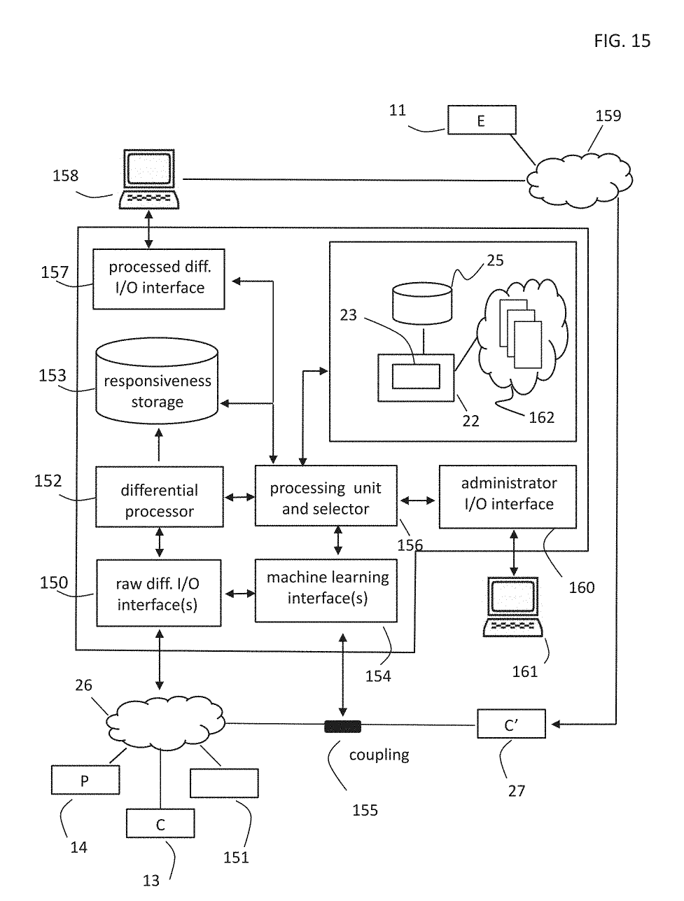

The process action of node 129 may be operated by the system remotely where the system's processes and software instructions are transferred, stored and embedded in the created certificated interests as a smart contract or similar remotely operating arrangement; all or part of the executable system instructions, are transferred to and executed on the certificated interests as independently operable code. In each case, the certificated interests are either created by the system with embedded operability or modified at a subsequent time by the system to include embedded operability. Referring briefly to FIG. 15 at certificated interests with embedded operability at 162 (as further detailed below), the certificated interests with embedded operability possess the self-modifying instruction set to achieve the accuracy, speed, and economic benefits of the disclosed embodiment. The embedded operability certificates may be implemented in a distributed ledger arrangement, a decentralized ledger arrangement, or similar arrangement where system modified certificates are transacted and held directly or indirectly by beneficial holders without a traditional centralized custodian or traditional transfer agent functions.

Referring to FIG. 15, it is to be understood that the disclosed embodiment includes receiving links to measure for differentials, store differentials, process of differentials, and enter into related modifications, and data transmission communication modes. In a configuration example, computer node 23 indicates where differentials measurement, storage, modification, and transmission processing software are stored on system RAM 22. The system software instructs the system continuously relating to all aspects of the differentials monitoring, storage including response curve related data, modification sequencing including process action node selection, and transmission and reevaluation of processes, where each function may possess two-way communication links to an electronic exchange and internet data stream. In the figure illustration, local storage is also provided for at storage device 25. Software remote co-location 162 provides for operation of the system in a distributed or decentralized format such as a blockchain implementation where software is distributed via an internet link across multiple interests or holdings where software relating to at least one of the process actions is co-located for the purpose of autonomous distributed operation.

Continuing with FIG. 15, system subprocesses for receive-mode communications are run through raw I/O interface 150, where the interface is connected to collective positions input 14, collective vehicle interest data 13, and other index or reference data streams 151 all through internet price data stream 26. Differentials are processed at differential processor 152 and “processing unit and selector” 156, where both differentials, and data relating to the differentials, including system generated responsiveness curves are stored at differential storage 153. Processing unit and selector 156 operate with processed differentials isolated at differential processor 152 and differential storage data at differential storage 153 (which may contain look-up tables, administrator rules and limitations, and experiential numerical and analytic based functionality), and the system action is translated into process selection and magnitude selection for transmission to processed differential I/O interface 157 for transmission into at least one electronic market exchange.

Continuing with FIG. 15, system outcomes are translated into process actions and magnitudes which are translated into computerized electronic trading instructions and order delivery at 158, where they are transmitted via an internet or network connection 159 to exchange 11 for execution. Following execution, the collective vehicle (C) at 13 has been modified or transformed into collective-vehicle-prime (C′) 27 where at least on parameter or order of magnitude has changed when compared to collective vehicle 13. Coupling 155 links monitoring of the collective-vehicle-prime 27 outcome, where the projected outcomes transmitted to the processed differential I/O interface 157 are compared with realized outcomes for efficacy based on the system experiential data and projection processes; machine learning nodes and sub processors capture the new data for the purposes of storage in the experiential datasets and for the purposes of modifying responsiveness projections. Finalizing FIG. 15, collective-vehicle-prime 27 is then assumed to become collective vehicle 13 for the purposes of the next monitoring and processing cycle, and the processes are repeated. System access may be gained through terminal 161 connected via an administrator I/O interface 160.

It is noted that system real-time monitoring processes are performed continuously during an electronic trading session and modifications of certificated interests are performed either during or following the close of an electronic trading session. Continuously operating system processes are expected to improve the accuracy of electronic trading because the system obviates the delays and reliance on uncontrolled independent actors seeking, finding, and acting on arbitrage conditions, and the systems recursive processes will independently force electronic trading equilibriums and correct data inaccuracies in system directed operating cycles.

The interactions between system software, electronic exchanges, and internet streamed datasets are continuously running the real-time processes which encompass the broad system process steps and a number of sub-steps where data-related system cycles and electronic trading cycles run in intervals of less than 60 seconds, and steps and sub-steps relating to the creation and modification of certificated interests are capable of running in intervals of less than 60 minutes following the close of each electronic market trading session including the transmission of system modifications to electronic exchanges, registrars, custodians (as applicable), market data streams, and media outlets.

The disclosed embodiment is uniquely suited to the implementation of systems, processes, and the modification of responsive collective vehicles to produce electronic trading improvements and improved data accuracy in collective vehicle data disseminations. In particular, the disclosed embodiment introduces unique and particular improvements to data and the electronic trading environment of a type of collective investment vehicle commonly referred to as active-nontransparent (or sometimes only nontransparent) where one or more collective vehicle positions are not publicly disclosed on a daily basis (or other frequency) required to be adequately monitored by unrelated participants. Nontransparent vehicles seek to merge the characteristics of the continuous and intra-session tradability of standard vehicles (including ETFs) with the proprietary strategies of active or non-index based strategies; non-transparent vehicles can be challenged because, with immediate and full transparency, other opportunistic traders may front-run the strategy by buying or selling securities in anticipation of the vehicle's moves which will either destroy or frustrate the strategy execution. A number of features in the disclosed embodiment's systems are designed to automatically monitor and correct for conditions where the electronic trading of independent actors fails to deliver rapid, accurate and cost effective equilibriums; by their very nature, nontransparent vehicles are expected to introduce information gaps which will suppress opportunistic electronic trading arbitrage upon which system processes would be invoked.

The disclosed embodiment's connectivity and embedded recursive processes are uniquely designed to operate automatically in real-time electronic trading environments which are otherwise unstable, limited by computational irreducible, and reliant on uncontrollable independent agents for accuracy. In some implementations, the disclosed embodiment substitutes traditional closed-form or analytic software rules with dynamically responsive and recursive systems, controlled by related software and connectivity, which dynamically respond to unknown conditions, actively monitor electronic trading responses to system engagement, and create and modify certificated interests and their internet distributed time series data output to create equilibrium electronic trading conditions with greater accuracy more quickly and with fewer transaction cycles. Relating to the dynamic and recursive processes, in some implementations, the systems of the disclosed embodiment will incorporate basic machine learning relating to the selection and sequencing of the system steps. In its operations, the system will: monitor a range of electronic trading prices and index levels, determine one or more correcting sub-processes, execute the sub-processes, and reevaluate the new range of electronic trading prices for outcomes including reductions in premiums, discounts, or differentials from target objectives. In these processes of evaluation, response, and reevaluation, the system will store optimizing information to be utilized for faster recursive responsive in subsequent electronic trading sessions. In many implementations, the system is expected to successfully achieve targeted objectives in the absence of effective hedging and effective risk management.

The above disclosed embodiments are not intended to limit the scope of the invention but are examples thereof. Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the scope and spirit of the present invention as defined by the appended claims.

What is claimed is:

1. A method for improved functioning of a specialized computer system, where the method is implemented on the specialized computer system having a processor and a server configured by non-transitory computer readable media, and when executed performs the method comprising:
linking at least one storage device to real time data from at least one internet disseminated electronic data stream; wherein the at least one internet disseminated electronic data stream includes collective vehicle electronic trading data and at least one additional data series from a list that includes an internet disseminated index, an electronically tradable contract, an electronically tradable security, and any combination thereof;
time sequencing or time shifting data from the at least one internet disseminated electronic data stream for transforming a plurality of separate items and a plurality of separate observations of the separate items into a plurality of coincidental and time ordered records that is storable and processable;
measuring the coincidental and time ordered records for presence of at least one measured differential including at least one discount condition, at least one premium condition, or any combination thereof for system subroutine selection and for including an alteration of collective vehicle electronic data for a collective vehicle, and a redirection of data values underlying the at least one measured differential to a plurality of regular owners, and not for purposes of risk management or risk hedging;
selecting a process action mode by reference to an administrator input, a stored predictive analysis data, a stored data, or any combination thereof; and
directing a portion of the at least one measured differential through the process action mode is applied to the regular owners of interests of the collective vehicle, wherein the regular owners of interests are identified by the specialized computer system from entries on at least one electronic ledger, and wherein system processes run in parallel to hedging and risk management processes, and wherein the system processes operate regardless of whether the collective vehicle is in a hedged or an unhedged state.

2. The method of claim 1, wherein the system processes operate continuously in a monitoring mode and selectively in the processing action mode, wherein the processing action mode is invoked by one or more differentials in an electronic trading price exceeding a threshold; and wherein a sub-process of monitoring and modification run repeatedly and recursively, and the system repeatedly monitors impact and efficacy of a system cycle modification, individually and cumulatively.

3. The method of claim 1, wherein one or more positions of the collective vehicle is non-publicly disclosed with a frequency sufficiently to ensure a continuous electronic arbitrage engagement of a plurality of independent agents on at least one electronic data outlet or at least one electronic news outlet; and
wherein a system process modification is applied to at least one certificated interest in response to the at least one measured differential.

4. The method of claim 1, wherein an electronic trading price of at least one certificated interest is targeted to maintain a value equal to the level of an index in addition to maintaining relative percentage change moves with the index, system modifications will be automatically invoked in response to the index which may result in process actions, which vary in timing and magnitude from modifications guided strictly by the at least one measured differential.

5. The method of claim 1, further including:
storing part or all of a system software, an operating instruction, a computer controlled process, or any combination thereof within an interest of the collective vehicle;
remotely modifying at least one certificated interest through operation and execution of the system software, the operating instruction, the computer controlled process or any combination thereof in response to the at least one measured differential for increasing accuracy of an electronic trading data, and an electronic trading value as compared to accuracy without the remote modification; and
wherein a portion of the at least one measured differential is directed to a change in the electronic trading value.

6. The method of claim 1, further including:
classifying a market condition for aligning similar characteristics within stored experiential data, wherein the similar characteristics includes a collective vehicle type, a position, and a monitored market condition including an electronic trading value;
modifying at least one certificated interest through the process action mode wherein the modification is automatically determined regarding a selection and a magnitude by the specialized computer system with reference to an internal stored data;
revising and storing a plurality of parameters relating to the internal stored data, including system measured responses to the electronic trading value of the at least one certificated interest, for system modification in subsequent cycles; and
preparing predictive estimates for the subsequent system cycles through application of the internal stored data, and a measurement of electronic prices in internet data streams.

7. A non-transitory computer readable storage medium comprising storage, retrieval, modification, measurement and linking system software which instructs at least one computer processor residing on a specialized computer system to implement a process to:
link at least one storage device to real time data from at least one internet disseminated electronic data stream where the at least one internet disseminated electronic data stream includes collective vehicle electronic trading data and at least one additional data series from a list comprising an internet disseminated index, an electronically tradable contract, and an electronically tradable security;
time sequence or time shift data from the at least one internet disseminated electronic data stream such that separate items and separate observations of the separate items are storable and processable as coincidental and time ordered records;
measure the coincidental and time ordered records for the presence of at least one measured differential for system subroutine selection and for purposes including the alteration of collective vehicle electronic data, and a redirection of data values underlying the at least one measured differential to regular owners, and not for the purposes of risk management or risk hedging;
select a process action by reference to administrator input, stored system operational guidance, or any combination thereof;
direct a portion of the at least one measured differential through the process action to the regular owners of interests of the collective vehicle, where the regular owners of interests are identified by the specialized computer system from entries on at least one electronic ledger, and where the system processes run in parallel to any risk hedging and risk management processes, and where system processes operates regardless of whether the collective vehicle is in a hedged or unhedged state with respect to risk management.

8. A system comprising:
a system having a memory device, the memory device further including a Random Access Memory (RAM);
a processor connected to the memory device, the processor configured to:
linking at least one storage device to real time data from at least one internet disseminated electronic data stream comprising collective vehicle electronic trading data and at least one additional data series comprised of at least one of an internet disseminated index, an electronically tradable contract, and an electronically tradable security;
time sequencing or time shifting data from the at least one internet disseminated electronic data stream such that separate items and separate observations of the separate items are storable and processable as coincidental and time ordered records;
measuring the coincidental and time ordered records for the presence of at least one measured differential for system subroutine selection and for purposes including an alteration of collective vehicle electronic data, and a redirection of data values underlying the at least one measured differential to regular owners, and not for purposes of risk management or risk hedging;
selecting a process action by reference to administrator input, stored system operational guidance, or any combination thereof;
directing a portion of the at least one measured differential through the process action to the regular owners of interests of the collective vehicle, where the regular owners of interests are identified by the specialized computer system from entries on at least one electronic ledger, and where the system processes run in parallel to risk hedging and risk management processes, and where system processes will operate regardless of whether the collective vehicle is in a hedged or unhedged state with respect to hedging or risk management.
